(19) United States
(12) Patent Application Publication
(10) Pub. No.: US 2018/0309940 A1
(43) Pub. Date: Oct. 25, 2018

(54) IMAGE PROCESSING APPARATUS, IMAGE PROCESSING METHOD, AND IMAGING SYSTEM

(71) Applicant: SONY CORPORATION, TOKYO (JP)

(72) Inventors: SHUNJI OKADA, KANAGAWA (JP); RYOTA KOSAKAI, TOKYO (JP); SHINJI UKITA, TOKYO (JP); EIJI OBA, TOKYO (JP); TSUYOSHI MASUZAWA, KANAGAWA (JP); MASAKAZU EBIHARA, TOKYO (JP); KAZUHIRO SHIMAUCHI, TOKYO (JP)

(21) Appl. No.: 15/529,555

(22) PCT Filed: Oct. 21, 2015
(86) PCT No.: PCT/JP2015/005314

§ 371 Date: May 25, 2017

(30) Foreign Application Priority Data
Dec. 4, 2014 (JP) 2014-246172

(51) Int. Cl. H04N 5/33; H04N 9/44; H04N 9/64; H04N 9/04; H04N 9/09

(52) U.S. Cl. CPC H04N 5/33; H04N 9/44; H04N 9/64; G06T 3/4053; H04N 9/09; H04N 2209/048; H04N 9/0451

(57) ABSTRACT

There is described an imaging method and an imaging device including first imaging circuitry that captures at least near infrared (NIR) light and outputs an NIR image, second imaging circuitry that captures far infrared (FIR) light and outputs an FIR image, wherein the FIR light has a longer wavelength than the NIR light, and processing circuitry configured to adjust color of the NIR image based on the FIR image.

### CROSS REFERENCE TO RELATED APPLICATIONS

This application claims the benefit of Japanese Priority Patent Application JP 2014-246172 filed Dec. 4, 2014, the entire contents of which are incorporated herein by reference.

### TECHNICAL FIELD

The present disclosure relates to an image processing apparatus, an image processing method, and an imaging system.

### BACKGROUND ART

While a lighting condition is an important element in the case where performing photography by using an imaging apparatus such as a camera, the lighting condition will change significantly depending on the photographing environment. Further, since an appropriate image processing method will differ in accordance with the lighting condition, face region extraction technology has been disclosed, such as in PTL 1, for example, in which variations of the lighting condition are considered.

On the other hand, in the fields of security cameras, vehicle cameras or the like, there is a demand for wanting to photograph a bright picture in a location with a dark lighting condition (dark place). It will be difficult to only perform imaging by visible light (light with a wavelength of 400 nm to 700 nm) in order to photograph brightly in a dark place. Here, many objects strongly reflect near infrared light (light with a wavelength of 700 nm to 2.5 μm) at a level approximately the same as that of visible light or at that of visible light or higher. Further, a heat source such as a living thing reflects far infrared light (light with a wavelength of 8.0 μm or higher). Accordingly, there are cases where cameras are used which include an imaging element capable of receiving infrared light for photographing in a dark place, and processing technology of an infrared light image acquired as a result of this has also been researched (for example, PTL 2).

Incidentally, while an imaging element of a camera generally used for visible light photography has a strong light receiving sensitivity to not only visible light but also to near infrared light, an imaging element such as that described above usually receives only visible light, and does not receive infrared light, due to an infrared light removal filter (IRCF). Since the imaging element receives not only visible light but also receives near infrared light when performing photography by removing the IRCF from the camera, it is possible to photograph more brightly in a dark place.

### CITATION LIST

### Patent Literature

[PTL 1]

JP 2004-192129A

[PTL 2]

JP H10-260078A

### SUMMARY

### Technical Problem

However, unlike visible light, there is no color distinction in near infrared light, and a reflection characteristic for near infrared light of an object generally differs from a reflection characteristic for visible light of this object. Therefore, the color and luminance of an image acquired by using an imaging element capable of receiving near infrared light will often appear unnatural to the human eye. Further, in the case where an imaging element capable of receiving visible light and near infrared light such as that described above is used, there will be cases where the balance of color and luminance collapses due to the influence of near infrared light, and an image which appears unnatural to the human eye is acquired.

Accordingly, an embodiment of the present disclosure proposes an image processing apparatus, an image processing method and an imaging system capable of compensating the color or luminance of an image obtained based on an imaging element having sensitivity to near infrared light.

### Solution to Problem

According to one embodiment there is described an imaging method and an imaging device including first imaging circuitry that captures at least near infrared (NIR) light and outputs an NIR image, second imaging circuitry that captures far infrared (FIR) light and outputs an FIR image, wherein the FIR light has a longer wavelength than the NIR light, and processing circuitry configured to adjust color of the NIR image based on the FIR image.

According to another embodiment there is described an apparatus including processing circuitry configured to obtain a first image from one or more imaging circuitry that captures at least a first wavelength light, obtain a second image from the one or more imaging circuitry that captures at least a second wavelength light which is longer than the first wavelength light, and generate at least one of color correction information and/or luminance correction information based on the second image for application to the first image.

According to another embodiment there is described an apparatus including a far infrared (FIR) light imager configured to generate image information, and processing circuitry configured to: obtain temperature information from the generated image information, determine color information in accordance with the temperature information, and output the color information.

### Advantageous Effects of Invention

According to an embodiment of the present disclosure such as described above, it is possible to compensate the color or luminance of an image obtained based on an imaging element having sensitivity to near infrared light.

Note that the effects described above are not necessarily limited, and along with or instead of the effects, any effect that is desired to be introduced in the present specification or other effects that can be expected from the present specification may be exhibited.

### BRIEF DESCRIPTION OF DRAWINGS

FIG. 1 is an explanatory diagram which shows an outline of an imaging system according to an embodiment of the present disclosure.

FIG. 2 is an explanatory diagram which shows a configuration example of a CMOS imaging apparatus according to related technology of the present disclosure.

FIG. 3 is an explanatory diagram which shows RGB pixel spectral sensitivity characteristics of a CMOS sensor.

FIG. 4 is an explanatory diagram which shows photographic subject reflection characteristics in imaging by a CMOS sensor.

FIG. 5 is an explanatory diagram which shows a configuration of an imaging system according to the present embodiment.

FIG. 6 is an explanatory diagram which shows an outline of decay compensation of an R pixel gain by a WB unit according to the present embodiment.

FIG. 7 is an explanatory diagram which shows photographic subject heat ray radiation characteristics in imaging by a far infrared imaging apparatus according to the present embodiment.

FIG. 8 is an explanatory diagram which shows an outline of a luminance compensation process by a luminance reproduction unit according to the present embodiment.

FIG. 9 is an explanatory diagram which shows an outline of a color compensation process by a color difference reproduction unit according to the present embodiment.

FIG. 10 is an explanatory diagram which shows examples of objects detected by an object region detection unit according to the present embodiment.

FIG. 11 is a table which shows a relationship between a region specification process and a compensation process according to the present embodiment.

FIG. 12 is a table which shows a relationship between a frame rate and a synchronization interval of the CMOS imaging apparatus and the far infrared imaging apparatus according to the present embodiment.

FIG. 13 is an explanatory diagram which shows a synchronization timing between the CMOS imaging apparatus and the far infrared imaging apparatus according to the present embodiment.

FIG. 14 is an explanatory diagram which shows an outline of a motion estimation process according to the present embodiment.

FIG. 15 is an explanatory diagram which shows an outline of a space compensation process according to the present embodiment.

FIG. 16 is an explanatory diagram which shows the operations by a preparation sequence of the imaging system according to the present embodiment.

FIG. 17 is an explanatory diagram which shows the operations by a far infrared image processing sequence of the imaging system according to the present embodiment.

FIG. 18 is an explanatory diagram which shows the operations by a compensation sequence of the imaging system according to the present embodiment.

FIG. 19 is an explanatory diagram which shows spectral sensitivity characteristics of a CMOS sensor, in the case where a notch filter is inserted into the CMOS imaging apparatus, according to a modified example of the present embodiment.

FIG. 20 is an explanatory diagram which shows a configuration of the imaging system according to a modified example of the present embodiment.

FIG. 21 is an explanatory diagram which shows a light emission intensity of a near infrared light emission unit according to a modified example of the present embodiment.

FIG. 22 is an explanatory diagram which shows a hardware configuration of an image processing apparatus according to the present embodiment.

### DESCRIPTION OF EMBODIMENTS

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. Outline of the imaging system according to an embodiment of the present disclosure

2. Background

2-1. Related technology

2-2. Spectral sensitivity characteristics and photographic subject reflection characteristics

3. Configuration

3-1. Configuration of the CMOS imaging apparatus

3-2. Configuration of the far infrared imaging apparatus

3-3. Configuration of the image processing apparatus

4. Operations

4-1. Operations by the preparation sequence

4-2. Operations by the far infrared image processing sequence

4-3. Operations by the compensation sequence

5. Modified examples

5-1. First modified example

5-2. Second modified example

6. Hardware configuration of the image processing apparatus

7. Conclusion

### 1. OUTLINE OF THE IMAGING SYSTEM ACCORDING TO AN EMBODIMENT OF THE PRESENT DISCLOSURE

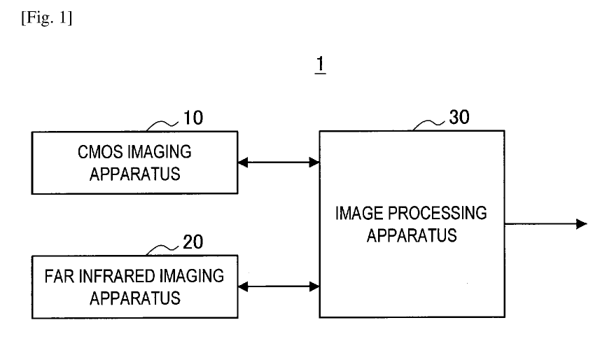

First, an outline of an imaging system according to an embodiment of the present disclosure will be described by referring to FIG. 1.

FIG. 1 is an explanatory diagram which shows an outline of an imaging system according to an embodiment of the present disclosure. As shown in FIG. 1, an imaging system 1 according to the present embodiment is an imaging system which has a CMOS imaging apparatus 10, a far infrared imaging apparatus 20, and an image processing apparatus 30.

The CMOS imaging apparatus 10 is an imaging apparatus which includes an imaging element (CMOS sensor) using a Complementary Metal Oxide Semiconductor (CMOS). The CMOS sensor is an example of an imaging element having sensitivity to visible light and near infrared light. Note that, the imaging element having sensitivity to visible light and near infrared light included in the imaging system according to an embodiment of the present disclosure is not limited to a CMOS sensor, and may be, for example, a Charge Coupled Device (CCD) sensor. The CMOS imaging apparatus 10 receives visible light and near infrared light when receiving a synchronization signal from the image processing apparatus 30, and provides an imaged signal, that is, a signal in which the visible light and near infrared light has been converted into a visible and near infrared image (second image), to the image processing apparatus 30.

The far infrared imaging apparatus 20 is an imaging apparatus which includes an imaging element having sensitivity to far infrared light. While the imaging element having sensitivity to far infrared light included in the imaging system according to an embodiment of the present disclosure is not limited to being related to this configuration or characteristic, the far infrared imaging apparatus 20 in the present embodiment includes an imaging element capable of imaging far infrared light, which is emitted by a substance of absolute 0 or higher itself, as a far infrared image (first image). A far infrared image is an image in which a value of each position within the image shows a photographic subject temperature of these positions. The far infrared imaging apparatus 20 receives far infrared light when receiving a synchronization signal from the image processing apparatus 30, and presents an imaged signal, that is, a signal in which far infrared light has been converted into a far infrared image, to the image processing apparatus 30. Note that, the far infrared imaging apparatus 20 is arranged at a position approximately the same as that of the CMOS imaging apparatus 10, is orientated in an approximately same direction, and images an approximately same space. Note that, in the case where the viewing angles of the far infrared imaging apparatus 20 and the CMOS imaging apparatus 10 are different, the viewing angles of both may be associated with each other, by having a part of the output of the imaging apparatus with the wider viewing angle cut out.

The image processing apparatus 30 is an information processing apparatus which has an image processing function. The image processing apparatus 30 sends a synchronization signal to the CMOS imaging apparatus 10 and the far infrared imaging apparatus 20, and receives image signals from the CMOS imaging apparatus 10 and the far infrared imaging apparatus 20. Further, the image processing apparatus 30 performs compensation of a visible and near infrared image, based on the received visible and near infrared image and the far infrared image. The image compensated by the image processing apparatus 30 is output to a monitor, recorded to a recording medium, or network sending is performed (not illustrated).

Note that, while an example has been shown in which the imaging system 1 in FIG. 1 includes the CMOS imaging apparatus 10, the far infrared imaging apparatus 20 and the image processing apparatus 30, the configuration of the imaging system according to an embodiment of the present disclosure is not limited to this. For example, the imaging system according to an embodiment of the present disclosure may be implemented by using an integrated apparatus by including a part or all of an imaging function of a visible and near infrared image, an imaging function of a far infrared image, and an image processing function.

### 2. BACKGROUND

Heretofore, an outline of the imaging system according to an embodiment of the present disclosure has been described. To continue, the background until reaching the creation of the imaging system according to the present embodiment will be described.

### 2-1. Related Technology

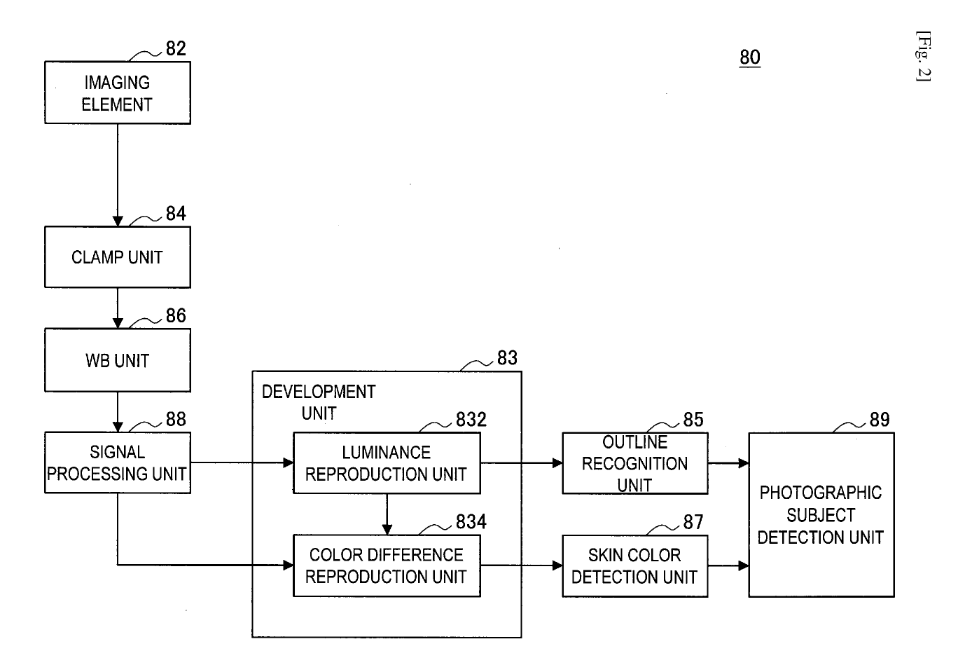

In order to easily understand the present embodiment, first, the related technology of the present disclosure will be described by referring to FIG. 2. FIG. 2 is an explanatory diagram which shows a configuration example of an imaging apparatus 80 according to the related technology of the present disclosure.

Which reference to FIG. 2, the imaging apparatus 80 is an imaging apparatus which includes an imaging element 82, a clamp unit 84, a WB unit 86, a signal processing unit 88, a development unit 83, an outline recognition unit 85, a flesh color detection unit 87 and a photographic subject detection unit 89. The imaging apparatus 80 includes an imaging function, and a function which detects a face (photographic subject) region from an acquired image.

The imaging element 82 is a CMOS sensor which images a photographic subject (converts light of a photographic subject into an image signal), and provides an image signal to the clamp unit 84. Usually, the imaging apparatus 80 includes an IRCF, which is not illustrated, and the imaging element 82 receives only visible light.

The clamp unit 84 removes an unnecessary offset element from the image signal received from the imaging element 82. The WB unit 86 estimates a lighted light source color temperature of a photographing environment, from the image signal in which the offset element has been removed, by referring to an internal black-body radiation color temperature estimation table, and performs a WB (white balance) adjustment for the image signal based on the estimated color temperature. The signal processing unit 88 performs a signal process such as demosaicing or gamma compensation for the image signal to which the WB adjustment has been performed, and provides an RGB (R: red, G: green, B: blue) signal generated as a result of the signal process to the development unit 83.

The development unit 83 includes a luminance reproduction unit 832 and a color difference reproduction unit 834. The development unit 83 separates the RGB signal into a luminance signal Y and color difference signals Cr and Cb, respectively performs processes by the luminance reproduction unit 832 and the color difference reproduction unit 834, and performs compensation so it becomes a natural image for humans.

The outline recognition unit 85 receives the compensated luminance signal from the luminance reproduction unit 832, and performs a recognition of outline information necessary for a detection of a face region. The flesh color detection unit 87 receives the compensated color difference signal from the color difference reproduction unit 834, and performs a detection of a flesh color region necessary for a detection of a face region. The photographic subject detection unit 89 respectively receives outline information and a flesh color region from the outline recognition unit 85 and the flesh color detection unit 87, and detects a face region.

Here, in the case where the imaging apparatus 80 performs imaging by including an IRCF, which is not illustrated, the imaging element 82 receives only visible light, and it is possible for each of the units of the imaging apparatus 80 to perform processes such as those described above. However, in the case where performing photography in a dark place, a very dark image will be imaged by only visible light. Since many objects strongly reflect near infrared light, performing visible and near infrared light photography, by an imaging apparatus which does not include an IRCF, can be considered to be useful, in particular, in the fields of security cameras and vehicle cameras.

However, in the case where imaging is performed without including an IRCF in the imaging apparatus 80, the imaging element 82 receives visible light and near infrared light, and so outputs an image signal receiving the influence of near infrared light. The image signal receiving the influence of near infrared light typically becomes an image signal generally taking on a quality of magenta, and in which the contrast is reduced. Here, it is difficult for the WB unit 86 to perform a light source color temperature estimation from an image signal receiving the influence of near infrared light, and as a result, the WB unit 86 is not able to perform a usual WB adjustment. Further, since the development unit 83 also performs compensation in the case where the imaging apparatus 80 includes an IRCF, in the case where the imaging apparatus 80 does not include an IRCF, the development unit 83 is not able to compensate a received image signal to a natural image for humans. In addition, in this case, since the recognition and detection accuracies of the outline recognition unit 85 and the flesh color detection unit 87 are reduced, a face region detection accuracy by the photographic subject detection unit 89 will also be reduced.

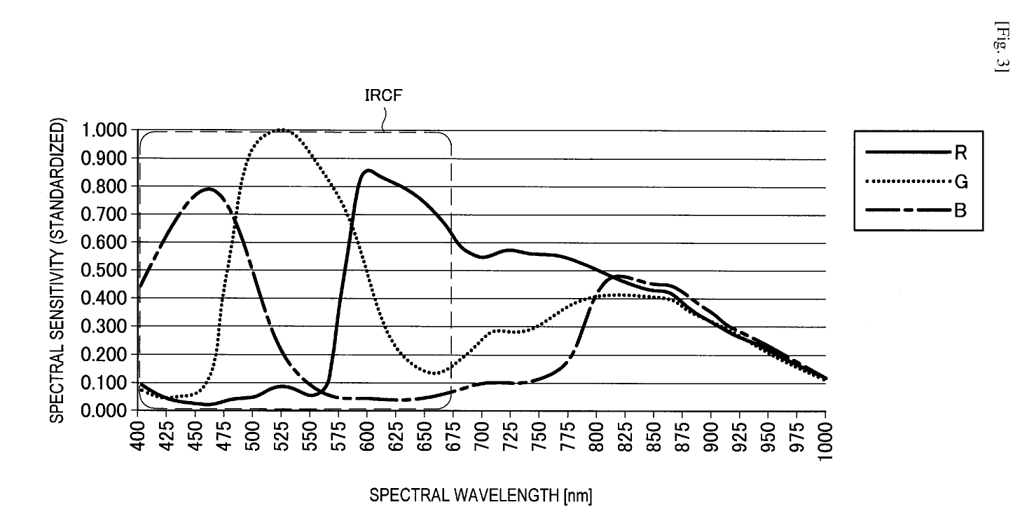

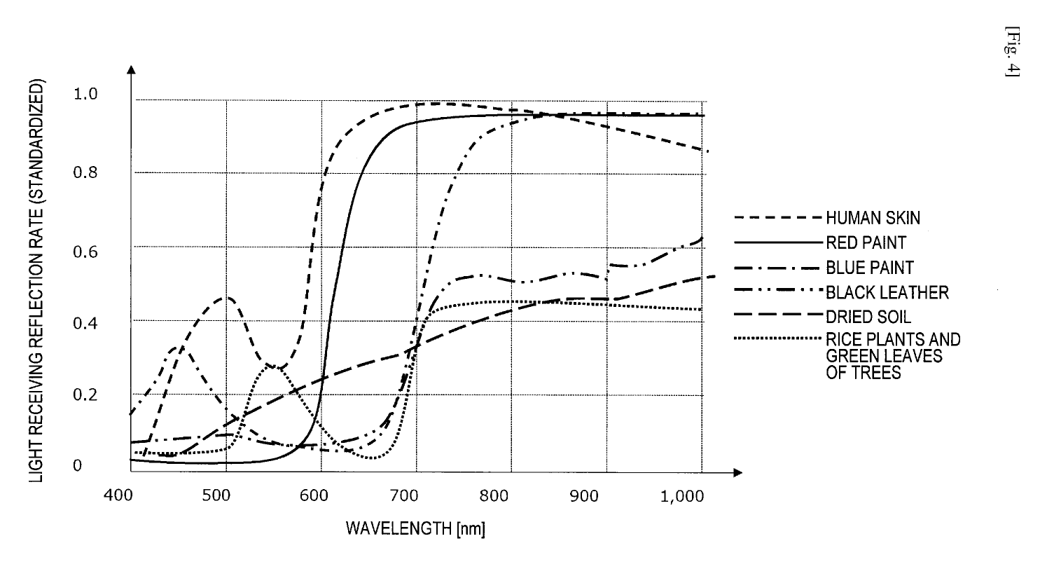

As described above, in the case where the imaging apparatus 80 receives near infrared light, there is the possibility that each unit of the imaging apparatus 80 will not be able to exhibit the original effect. Hereinafter, in order to clarify the cause of this, spectral sensitivity characteristics and photographic subject reflection characteristics of a CMOS sensor will be described by referring to FIGS. 3 and 4.

### 2-2. Spectral Sensitivity Characteristics and Photographic Subject Reflection Characteristics

FIG. 3 is an explanatory diagram which shows RGB pixel spectral sensitivity characteristics of a CMOS sensor. In the graph shown in FIG. 3, the solid line shows a spectral sensitivity characteristic of a red (R) pixel, the dotted line shows a spectral sensitivity characteristic of a green (G) pixel, and the single dash-dot line shows a spectral sensitivity characteristic of a blue (B) pixel. As shown in FIG. 3, in the case where light is received through an IRCF, the CMOS sensor receives only the visible light enclosed by the broken line, and in the case where light is received not through an IRCF, the CMOS sensor also has a light receiving sensitivity for near infrared light (from 700 nm).

As shown in FIG. 3, the R pixel has a light receiving sensitivity several times that of the G pixel and the B pixel, for near infrared light of approximately 700 nm to 800 nm. Further, the R pixel, the G pixel and the B pixel all have a light receiving sensitivity of approximately the same level, for near infrared light of 800 nm or higher.

Therefore, an image signal biased to red color is output from the CMOS sensor, in correspondence with an intensity of near infrared light of approximately 700 nm to 800 nm. Further, an image signal with a high luminance, a thin color and a low contrast is output from the CMOS sensor, in correspondence with near infrared light of 800 nm or more.

FIG. 4 is an explanatory diagram which shows characteristics of various types of photographic subject reflections in a visible and near infrared light range imaged by the CMOS sensor. In the graph shown in FIG. 4, the broken line shows a reflection characteristic of human skin, the solid line shows a reflection characteristic of red paint, the single dash-dot line shows a reflection characteristic of blue paint, the double dash-dot line shows a reflection characteristic of black leather, the long broken line shows a reflection characteristic of dried soil, and the dotted line shows a reflection characteristic of rice plants and green leaves of trees. Hereinafter, the features of image signals output as a result of various types of photographic subjects being imaged by a CMOS sensor will be described, in accordance with the spectral sensitivity characteristics of FIG. 3 and the photographic subject reflection characteristics of FIG. 4.

As shown in FIG. 4, the reflection rate of human skin has the feature of being high in the near infrared light region (from 700 nm). Note that, while human skin has light and dark differences depending on race, the hue is the same. Since the reflection rate of human skin is high in the near infrared light region, the luminance will be saturated, in visible and near infrared light photography of a human face, and the contrast will be reduced compared to the case of visible light photography.

As shown in FIG. 4, the reflection rate of red paint is high in the red spectral band in visible light, and is also high in near infrared light. Therefore, while a red hue remains, in visible and near infrared light photography of red paint, the luminance will be saturated, and so the color will be thin. Further, while the reflection rate of blue paint has a largest peak (approximately 30%) in the blue spectral band in visible light, it approaches 100% in the near infrared light region, and the reflection rate of blue paint in the near infrared light region is much higher than the reflection rate of blue paint in the blue spectral band. As described above, since the light receiving sensitivity of the R pixel is greater than the light receiving sensitivity of the B pixel in near infrared light of approximately 700 nm to 800 nm, the hue will shift from blue to purple, in visible and near infrared light photography of blue paint, the luminance will be saturated, and the color will be thin. Therefore, for example, information of characters, symbols and signs of road signs painted with red paint and blue paint will be very difficult to visually recognize, in visible and near infrared light photography.

The reflection rate in the visible light region of black leather, which is an animal skin, is 10% or less, while the reflection rate in the near infrared light region of this black leather is about 50%. Accordingly, black leather is reflected brighter, in visible and near infrared light photography, than in the case of visible light photography, and the contrast with the surroundings will be reduced.

The reflection rate of dried soil has a characteristic which monotonously increases on the long wavelength side in the visible light band, and dried soil has a color with a somewhat low brightness having red in visible light photography. On the other hand, since the reflection rate in the near infrared light region of dried soil reaches approximately 50%, dried soil is imaged brighter, in visible and near infrared light photography, than in the case of visible light photography.

The reflection rate of rice plants and green leaves of trees has a peak of approximately 25% centered on 550 nm of the visible light band, while reaching approximately 50% in the near infrared light region. A hue with a comparatively low brightness (dark) is imaged, in visible light photography of rice plants and green leaves of trees. However, as described above, since the light receiving sensitivity of the R pixel is greater than the light receiving sensitivity of the G pixel in near infrared light of approximately 700 nm to 800 nm, the hue will shift from green color to red color, and the luminance will be high, in visible and near infrared light photography of rice plants and green leaves of trees, and so there will be a feeling of incompatibility for humans. Since the reflection color of red is green in a uniform color space CIELAB which is assumed to correctly represent the hue senses of humans, a person will sense that the hue has been reversed when leaves stored in green color are displayed in red color.

Accordingly, it has reached creating the present embodiment by focusing on the above mentioned circumstances. According to the present embodiment, it is possible to compensate the color or luminance of an image receiving the influence of near infrared light. Hereinafter, a configuration of the present embodiment having such an effect will be described in detail.

### 3. CONFIGURATION

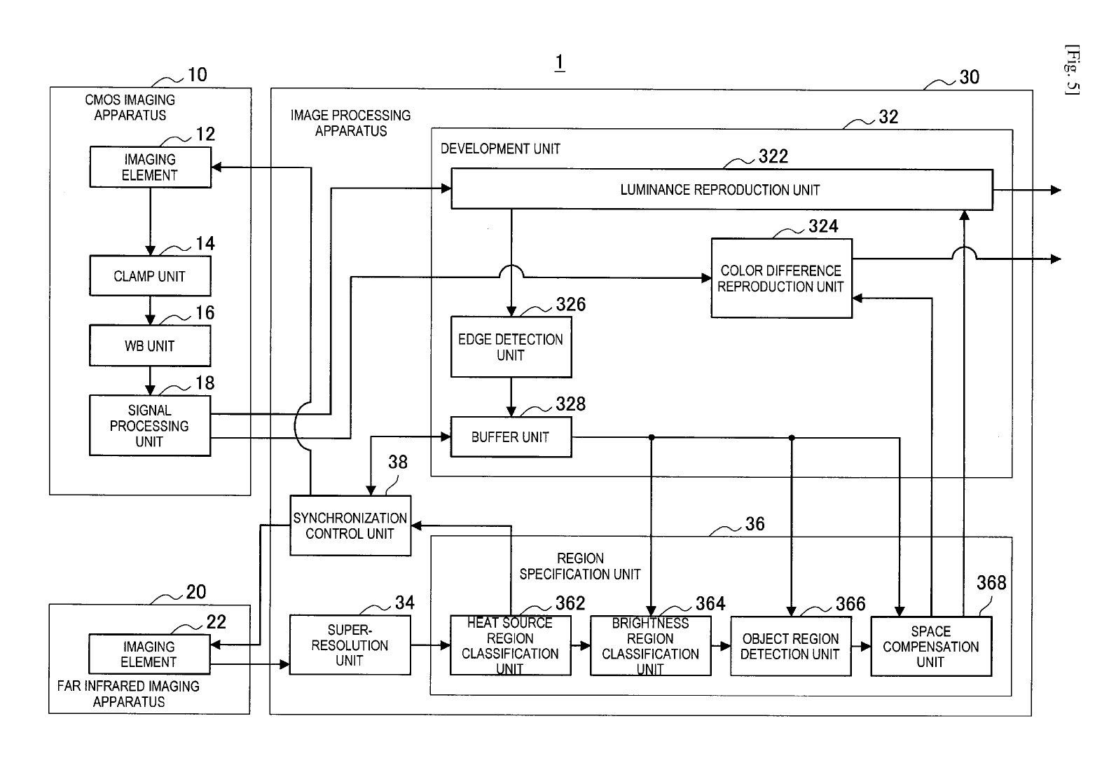

FIG. 5 is an explanatory diagram which shows a configuration of the imaging system 1 according to the present embodiment. Hereinafter, configurations of the CMOS imaging apparatus 10, the far infrared imaging apparatus 20 and the image processing apparatus 30 will be sequentially described in detail.

### 3-1. Configuration of the CMOS Imaging Apparatus

As shown in FIG. 5, the CMOS imaging apparatus 10 includes an imaging element 12 (second imaging element), a clamp unit 14, a WB unit 16, and a signal processing unit 18. Here, since the clamp unit 14 and the signal processing unit 18 respectively have functions the same as the clamp unit 84 and the signal processing unit 88 described with reference to FIG. 2, a description of them will be omitted. Note that, while not illustrated, the CMOS imaging apparatus 10 includes transparent glass or a plastic lens which transmits visible light and near infrared light.

The imaging element 12 is a CMOS sensor which converts light into an image signal, similar to the imaging element 82 described with reference to FIG. 2. The imaging apparatus 10 according to the present embodiment does not include an IRCF, and the imaging element 12 receives visible light and near infrared light. Further, when a synchronization signal is received from the image processing apparatus 30, the imaging element 12 provides an image signal to the clamp unit 14. Note that, the imaging element 12 according to the present embodiment may be driven at a frame rate such as 30 fps, 60 fps, 120 fps or 240 fps, for example, or may be driven at 24 fps as a cinema mode.

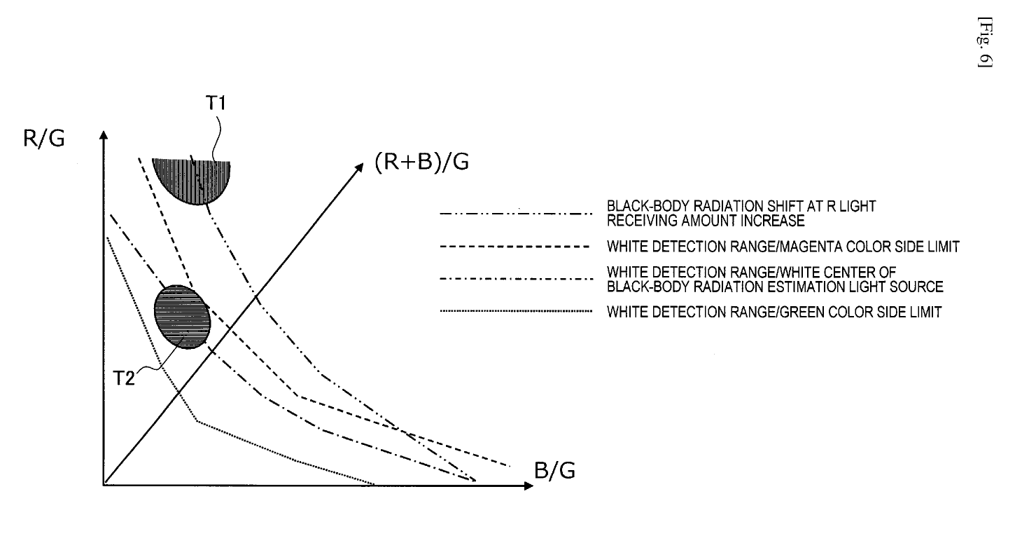

The WB unit 16 has a function of a light source color temperature estimation and a function of a WB adjustment, similar to the WB unit 86 described with reference to FIG. 2, and the WB unit 16 additionally includes a decay compensation (offset) function of a red (R) pixel gain. FIG. 6 is an explanatory diagram which shows an outline of decay compensation of an R pixel gain by the WB unit 16. In the graph shown in FIG. 6, the broken line shows the limit of a magenta color side of a range in which the WB unit 16 is capable of estimating a light source color temperature, and the dotted line shows the limit of a green color side of a range in which the WB unit 16 is capable of estimating a light source color temperature. Further, in the graph shown in FIG. 6, the single dash-dot line shows a path of a white center (black-body radiation) of the case where a color temperature has been changed by setting black-body radiation as an estimation light source, and the double dash-dot line shows black-body radiation in which a shift has occurred by having a light receiving amount of the R pixel increase at the time of visible and near infrared imaging.

In the case where the imaging element 12 which is a CMOS sensor receives near infrared light, it will be easy for the light receiving amount of the R pixel to increase such as described above, and the characteristic of white of the black-body radiation color temperature such as shown by the double dash-dot line in the graph of FIG. 6 will shift significantly in the increasing direction of (R+B)/G (magenta color direction). In the case where an image signal is input in this state, the image signal will be distributed in the region shown by T1 of FIG. 6, and will be positioned on an outer side than the magenta color side limit line of a white detection range shown by the solid line in the graph of FIG. 6, and so will not able to be drawn into white of the original black-body radiation color temperature by a usual WB control.

Here, based on the characteristic shift of white of the black-body radiation color temperature in an imaging state in which the light receiving sensitivity of the R pixel is increasing, the WB unit 16 decay compensates (offsets in a decay direction) the R pixel gain so that the region of T1 shown in FIG. 6 moves to the region of T2. For example, the WB unit 16 may perform compensation which causes the R pixel gain to decay in half. Further, the WB unit 16 performs an estimation of a usual light source color temperature and a WB adjustment, by decay compensating the R pixel gain and inputting this decay compensated R pixel gain to a color temperature estimation table.

Note that, even if a WB adjustment is usually performed, the above described image signal in which the brightness and hue has changed is not able to be compensated by the WB adjustment, and so it is desirable to perform compensation in correspondence with each photographic subject. Accordingly, compensation corresponding to each photographic subject (object) region is performed, by the image processing apparatus 30, which will be described below.

### 3-2. Configuration of the Far Infrared Imaging Apparatus

As shown in FIG. 5, the far infrared imaging apparatus 20 includes an imaging element 22 (first imaging element). Note that, while not illustrated, the far infrared imaging apparatus 20 includes a lens of a material which transmits far infrared light. High quality germanium in high quality goods, low-priced ZnS, chalcogenide, low-priced semiconductor silicon or the like can be included, for example, as a material which transmits far infrared light.

The imaging element 22 is an imaging element having sensitivity to far infrared light, and capable of imaging far infrared light, which is emitted by a substance of absolute 0 or higher itself, as a far infrared image. It is possible to adopt a microbolometer having a pixel plane array of a vacuum structure within an MEMS structure, for example, as the imaging element 22.

While it is possible for the imaging element 22 to be implemented, for example, as a microbolometer driven at 60 fps, the performance of far infrared sensors on the market capable of imaging far infrared light is restricted by the law, in order to prevent military use. In the present state, only far infrared sensors which satisfy the restrictions of a pixel number of 250,000 pixels or less and a frame rate of 9 fps or less are circulated on the market. Accordingly, the imaging element 22 in the present embodiment is also set as an imaging element in accordance with the above described restrictions.

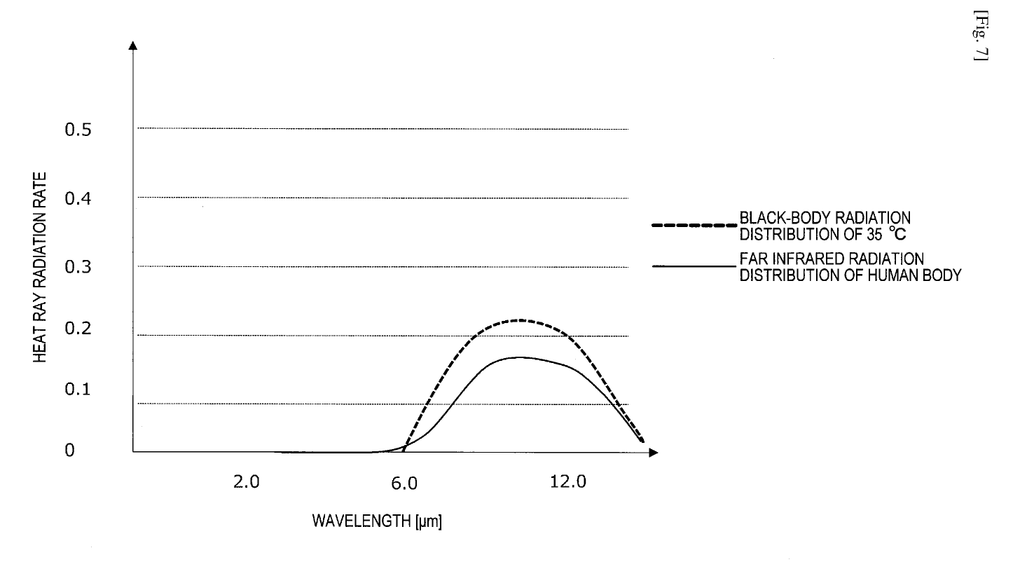

FIG. 7 is an explanatory diagram which shows photographic subject heat ray radiation characteristics in imaging by the imaging element 22. In the graph shown in FIG. 7, the broken line shows a characteristic of far infrared light radiated by a black-body of 35° C., and the solid line shows a characteristic of far infrared light radiated by a human body. All substances radiate electromagnetic radiation, that is, a heat ray (far infrared light), corresponding to the temperature which the substance has. That imaged by the imaging element 22 is radiation heat of an object, and a heat ray wavelength distribution of this approximates the black-body radiation of this temperature. As shown in FIG. 7, for example, the far infrared radiation distribution of a human body or a type of living warm-blooded mammal is a wavelength range of mainly 8 μm to 12 μm, and has a distribution characteristic of spectral energy radiation of black-body radiation or lower, which is near to the black-body radiation of approximately 35° C. corresponding to a body temperature. The imaging element 22 images this heat ray (far infrared light), and a value of each position within an image is converted into a signal of a far infrared image which shows a temperature of the photographic subject of these positions. The image processing apparatus 30, which will be described below, classifies each pixel of the far infrared image into regions having a heat source and regions not having a heat source.

Further, when a synchronization signal is received from the image processing apparatus 30, the imaging element 22 provides a far infrared image signal to the image processing apparatus 30. Here, in the present embodiment, the number of short-distance images obtained in a prescribed time is greater than the number of far infrared images obtained in this prescribed time. As described above, the frame rate of the far infrared imaging apparatus 20 in the present embodiment is 9 fps or less, and the frame rate of the CMOS imaging apparatus 10 is 24 to 240 fps. Accordingly, the imaging element 22 performs a provision of a far infrared image signal, once each time a synchronization signal is received a prescribed number of times.

### 3-3. Configuration of the Image Processing Apparatus

As shown in FIG. 5, the image processing apparatus 30 includes a development unit 32, a super-resolution unit 34, a region specification unit 36, and a synchronization control unit 38.

(Development Unit)

The development unit 32 includes a luminance reproduction unit 322, a color difference reproduction unit 324, an edge detection unit 326, and a buffer unit 328. An RGB signal input from the signal processing unit 18 to the development unit 32 is separated into a luminance signal Y and color difference signals Cr and Cb, and the luminance signal Y and color difference signals Cr and Cb are respectively input to the luminance reproduction unit 322 and the color difference reproduction unit 324.

The luminance reproduction unit 322 provides the luminance signal to the edge detection unit 326. Further, the luminance reproduction unit 322 includes a function as a compensation unit which performs luminance compensation for the luminance signal. Here, the luminance reproduction unit 322 performs luminance compensation, in accordance with information of a region category of a compensation target region received from the region specification unit 36, which will be described below, by a method which compensates the brightness and contrast of this compensation target region.

FIG. 8 is an explanatory diagram which shows an outline of a luminance compensation process by the luminance reproduction unit 322. The luminance reproduction unit 322 according to the present embodiment performs either of two types (two characteristics) of luminance compensation for a compensation target region, in accordance with the region category of this compensation target region. In the graph shown in FIG. 8, the solid line shows a relationship between the luminance input and output, by luminance compensation of a characteristic #1 which is a first characteristic, and the single dash-dot line shows a relationship between the luminance input and output, by luminance compensation of a characteristic #2 which is a second characteristic. A correspondence between the region category and each characteristic will be described below. In the case where the compensation target region is a region category corresponding to the characteristic #1, the luminance contrast of this region improves such as shown in FIG. 8, and compensation for which the brightness is easily improved in a large portion of this region is performed for this region. On the other hand, in the case where the compensation target region is a region category corresponding to the characteristic #2, the luminance contrast of this region improves such as shown in FIG. 8, and compensation for which the brightness is easily reduced in a large portion of this region is performed for this region.

The color difference reproduction unit 324 includes a function as a compensation unit which performs color compensation for a color difference signal. First, the color difference reproduction unit 324 determines the presence or absence of a hue saturation objective value, in accordance with information of a region category of a compensation target region received from the region specification unit 36, which will be described below. In addition, the color difference reproduction unit 324 performs color compensation by a method which compensates the hue and saturation of this compensation target region so that the hue and saturation become this hue saturation objective value or within a prescribed range based on this hue saturation objective value.

Note that, the color difference reproduction unit 324 according to the present embodiment color space converts a color difference signal into a CIELAB uniform color space of an L*a*b color system, and performs compensation in this color space.

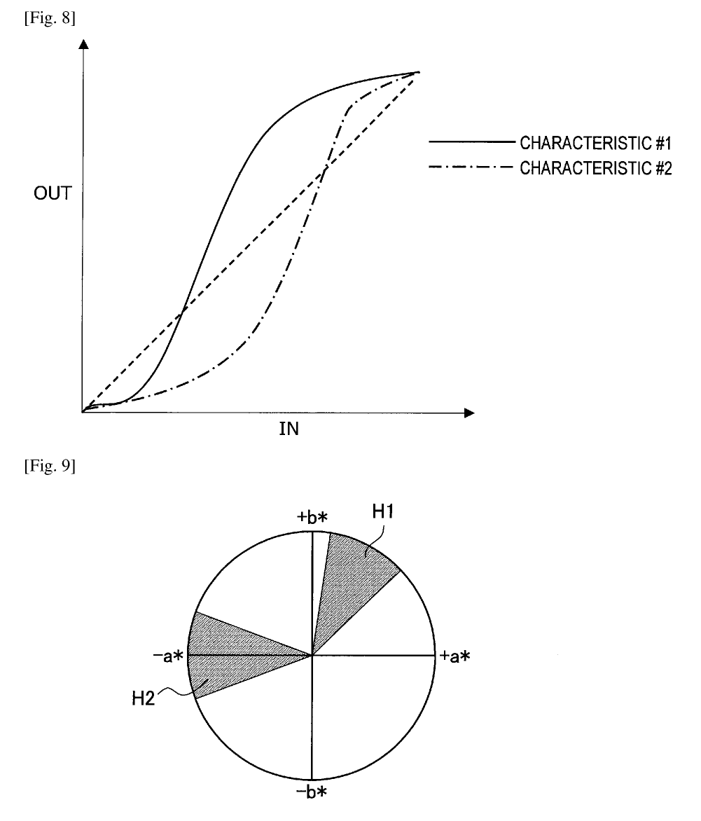

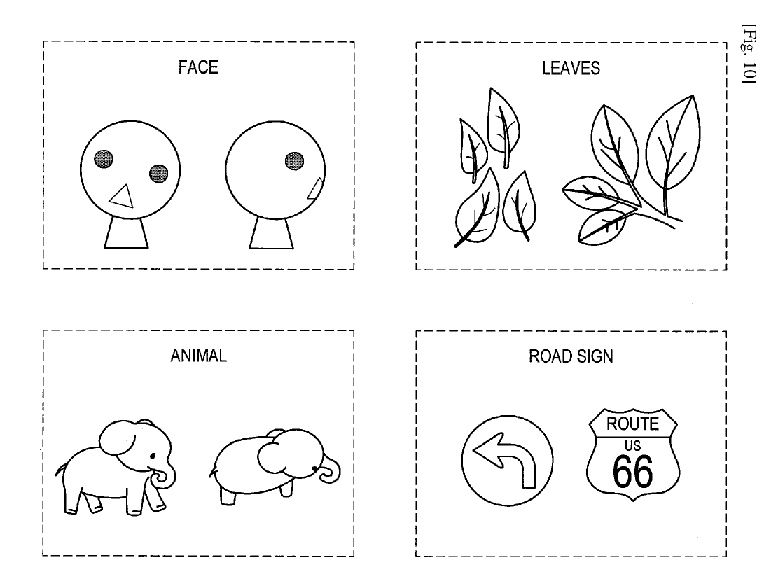

FIG. 9 is an explanatory diagram which shows an outline of color compensation by the color difference reproduction unit 324 according to the present embodiment. In FIG. 9, a* shows red color, -a* shows green color, b* shows yellow color and -b* shows blue color, and the saturation increases towards the outer circumference of the circle. In the present embodiment, values within a flesh color range H1 and a green color range H2 are used in the hue saturation objective value.

Note that, the image compensated by the luminance reproduction unit 322 and the color difference reproduction unit 324 is output to a monitor, recorded to a recording medium, or network sending is performed (not illustrated). In the case where the above described output to a monitor or the like is performed, an image signal may be converted into a Gamut color region defined as a video signal standard by 3D-LUT, and then afterwards output or the like may be performed. Further, compensation by the luminance reproduction unit 322 and the color difference reproduction unit 324 may be performed so as to fit within the range of a Gamut color region.

Further, in a frame in which the edge detection unit 326 fails an edge detection, which will be described below, or an edge is not detected, the luminance reproduction unit 322 performs compensation, for all or a part of the image of this frame, which causes the luminance to be reduced more than the above described luminance compensation process does. Further, the color difference reproduction unit 324 performs compensation, for all or a part of the image of this frame, which causes the saturation to be reduced more than the above described color compensation does. By this compensation, there will be an effect which reproduces an appearance of the case where blurring occurs by an imaged photographic subject moving at a high speed, or the case where the focus has shifted.

The edge detection unit 326 generates a brightness image in which each image of the luminance signal received from the luminance reproduction unit 322 is divided into a plurality of macro blocks, and detects an edge for each macro block obtained by the division from the brightness image. Further, the edge detection unit 326 provides the brightness image which has been divided into macro blocks, and detected edge information, to the buffer unit 328 as image feature information extracted from a visible and near infrared image.

Note that, the image processing apparatus 30 may include a plurality of Digital Signal Processors (DSP), or a DSP including a plurality of processor cores. It is possible for the image processing apparatus 30 including a plurality of DSPs or a DSP including a plurality of processor cores to perform the above described processes such as edge detection at high speed, by applying a parallel process by a DSP for the above described plurality of macro blocks.

The buffer unit 328 receives the brightness image and the edge information, which are image feature information, from the edge detection unit 326, and performs buffering. Further, the buffer unit 328 provides the brightness image and the edge information in a frame designated by the synchronization control unit 38 to the region specification unit 36.

(Super-Resolution Unit)

The super-resolution unit 34 performs a super-resolution process which receives a far infrared image from the far infrared imaging apparatus 20, and increases the resolution of the far infrared image. Further, the super-resolution unit 34 provides the far infrared image to which super-resolution has been performed to the region specification unit 36. In the case where a super-resolution process is performed for a far infrared image of some frame, the super-resolution unit 34 performs a super-resolution process by using difference information between this far infrared image and a far infrared image of the frame next to this frame in the imaging of the far infrared imaging apparatus 20. Therefore, a delay of one frame at the shortest occurs in the imaging of the far infrared imaging apparatus 20, by the super-resolution process of the super-resolution unit 34.

Since the far infrared image to be output by the far infrared imaging apparatus 20 has a pixel number of 250,000 pixels or less as described above, the accuracy of the following processes for the far infrared image is improved, by having the resolution of the far infrared image increased by the above described super-resolution process. Further, since the manufacturing cost of the far infrared imaging apparatus 20 becomes lower as the pixel number of the far infrared image decreases, an effect can be obtained which lowers the manufacturing cost of the far infrared imaging apparatus 20, by suppressing the pixel number of the far infrared image and compensating a necessary resolution by a super-resolution process.

(Region Specification Unit)

The region specification unit 36 specifies a compensation target region and a region category of this compensation target region, based on a photographic subject temperature of each position in a far infrared image, a brightness of each position in a visible and near infrared image, and image feature information buffered in the buffer unit 328, in the visible and near infrared image. For example, the region specification unit 36 specifies a detection target region and a detection object category, based on a far infrared image and a visible and near infrared image, in the visible and near infrared image, detects an object region corresponding to the detection object category from the specified detection target region, and specifies a compensation target region based on the detected object region. In addition, the region specification unit 36 performs a motion estimation based on image feature information extracted from the visible and near infrared image obtained at a first time, and image feature information extracted from the visible and near infrared image obtained at a second time after the first time. Also, the region specification unit 36 may specify an object region (reference region) detected (specified) in the visible and near infrared image obtained at the first time by setting a region obtained by compensating based on an estimated motion as a compensation target region. Hereinafter, a heat source region classification unit 362, a brightness region classification unit 364, an object region detection unit 366 and a space compensation unit 368, included in the region specification unit 36 for implementing the above described processes, will be sequentially described.

The heat source region classification unit 362 receives a far infrared image to which super-resolution has been performed from the super-resolution unit 34, and classifies each pixel of the far infrared image to which super-resolution has been performed into regions with a heat source and regions without a heat source. In the present embodiment, the heat source region classification unit 362 classifies regions with a temperature shown at this position of the far infrared image at a prescribed threshold or higher into regions with a heat source, and classifies regions with a temperature shown at this position of the far infrared image less than a prescribed threshold into regions without a heat source. The prescribed threshold may be, for example, 20° C. Further, when the heat source region classification process is completed for some frame, the heat source region classification unit 362 notifies information of the time at which this frame has been imaged to the synchronization control unit 38.

The brightness region classification unit 364 classifies a brightness image into a plurality of regions by allowing duplication of regions, based on a brightness image received from the buffer unit. The brightness region classification unit 364 in the present embodiment performs classification, by using a first threshold and a second threshold greater than the first threshold, and setting regions having a brightness greater than the first threshold as regions with a high to medium brightness, and setting regions having a brightness less than the second threshold as regions with a medium to low brightness.

Further, the brightness region classification unit 364 receives a heat source region classification result of the far infrared image from the heat source region classification unit 362, and provides a heat source region classification result in a brightness image, in which this classification result corresponds to the brightness image, to the object region detection unit 366 together with a brightness region classification result of the brightness image.

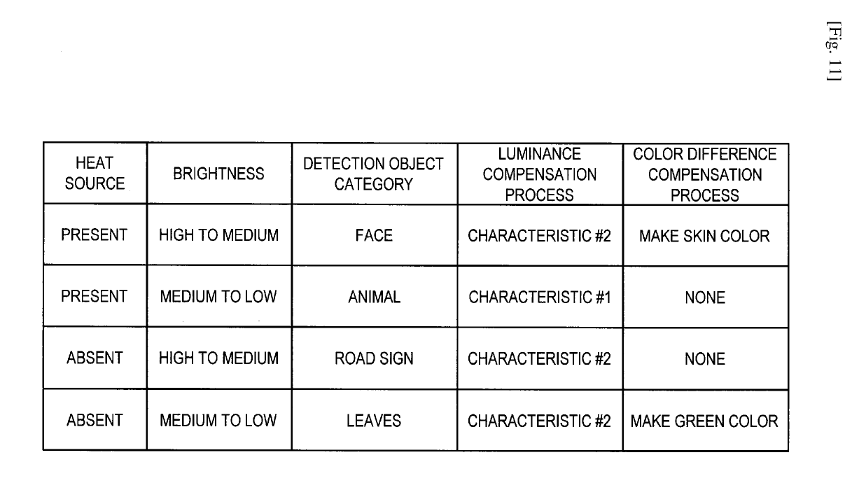

The object region detection unit 366 determines a detection object category, in accordance with the heat source region classification result and the brightness region classification result received from the brightness region classification unit 364, and detects an object region, based on the edge information received from the buffer unit 328. FIG. 10 is an explanatory diagram which shows an object category (detection object category) to be detected by the object region detection unit 366 in the present embodiment. As shown in FIG. 10, the object region detection unit 366 performs a detection of an object region, in visible and near infrared photography, for a face of a person in which the luminance is saturated and the color is lost (becomes white), an animal in which the contrast is reduced, leaves in which it is felt that a hue with a high luminance has been reversed, and a road sign in which the luminance is saturated. Note that, while a detection of an object region is performed for the above described 4 categories of objects in the present embodiment, the object region detection unit 366 may perform a detection of an object region for other categories of objects.

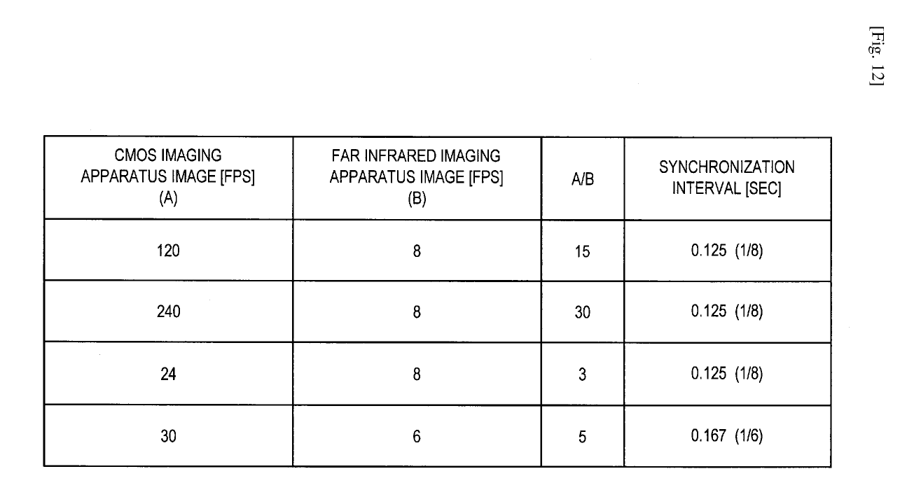

FIG. 11 is a table which shows a luminance compensation process and a color difference compensation (color compensation) process in the case where a detection object category corresponding to the heat source region classification result and the brightness region classification result, and an object region of this category, are detected. The object region detection unit 366 determines a detection object category, by referring to the table of FIG. 11. Since it will be easy for a detection error to occur when performing object region detection based on edge information for a whole image, an effect can be obtained which causes the accuracy of object region detection to be improved, by performing heat source region classification and brightness region classification, and thereafter performing a detection of an object of a category which is anticipated to exist in accordance with this result. Note that, the compensation process for each detection object category and this effect is as follows.

A luminance compensation process of a characteristic #2, which raises the contrast and lowers the brightness, and a color difference compensation process in which flesh color is designated as a hue saturation objective value, are performed for a region in which a face has been detected by a face feature pattern detection operation. In this way, the contrast and the brightness gradation are improved, and flesh color which is a storage color of a face (the color for which a human is stored as an image) is reactivated.

A luminance compensation process of a characteristic #1, which raises the contrast and also raises the brightness, is performed for a region in which an animal has been detected by an animal shape feature pattern detection operation. In this way, the visibility of an animal, which is inferior since the light reflection rate of near infrared light for the skin of an animal is low, is improved.

A luminance compensation process of a characteristic #2, which raises the contrast and lowers the brightness, is performed for a region in which a road sign has been detected by a road sign feature (external shape is round, square or the like) pattern detection operation. In this way, the visibility of a road sign, on which symbols and signs are difficult to distinguish since the paint of a road sign has a state in which the light reflection rate of near infrared light is near to 100% and the luminance is saturated, is improved. Note that, while a color difference compensation process for a region in which a road sign has been detected has been set to “none” in FIG. 11, a color difference compensation process may be performed by having a hue saturation objective value designated. For example, a color difference compensation process may be performed, by having the object region detection unit differentiate and detect a plurality of categories of road sign patterns, and by having a hue saturation objective value (blue, red or the like) corresponding to the categories of the road signs designated.

A luminance compensation process of a characteristic #2, which raises the contrast and lowers the brightness, and a color difference compensation (color compensation) process in which green color has been designated as a hue saturation objective value, are performed for a region in which leaves have been detected by a shape feature texture pattern detection operation of leaves of trees. In this way, a feeling of incompatibility by disassociation between a high reflection rate for near infrared light and a low reflection rate for visible light of leaves is improved, and green color which is a storage color of leaves is reactivated.

The space compensation unit 368 performs a motion estimation by comparing edge information of the present frame (second time T), and edge information of a frame (first time T−Δt) in which the object region detection unit 366 has completed an object region detection. Further, the space compensation unit 368 spatially compensates the object region (reference region) specified by the object region detection unit 366 based on the edge information (image feature information) of the time T−Δt, based on the above described estimated motion. Hereinafter, a relationship between the time T and the time T−Δt related to the space compensation unit 368 will be described, and thereafter a description of motion estimation and a description of space compensation will be sequentially performed.

As described above, since the CMOS imaging apparatus 10 and the far infrared imaging apparatus 20 have different frame rates, the total of a delay by the super-resolution process and a synchronization delay for synchronizing different frame rates will become a delay Δt. Since an object region and an object category of the present frame are obtained by space compensation of the space compensation unit 368, regardless of a delay At such as described above occurring, there will be an effect in which a real-time luminance reproduction process and color difference reproduction process are made possible in space compensation.

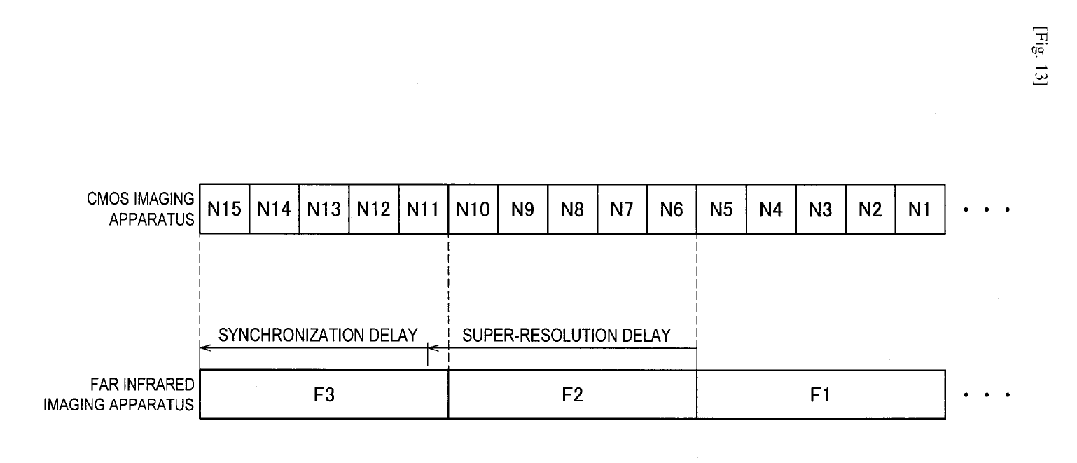

FIG. 12 is a table which shows an example of frame rates and synchronization intervals in the case where the CMOS imaging apparatus 10 and the far infrared imaging apparatus 20 are both made to perform synchronization drive imaging at different frame rates. Here, the frame rate of the far infrared imaging apparatus 20 is restricted to 9 fps or less as described above. As shown in FIG. 12, in the case where the CMOS imaging apparatus 10 is driven at 30 fps, for example, the far infrared imaging apparatus 20 is driven at 6 fps, both are synchronized every 5 frames in the CMOS imaging apparatus 10, and this synchronization interval is 0.167 seconds (⅙ seconds). Hereinafter, a case will be described, as an example, where this CMOS imaging apparatus 10 is driven at 30 fps.

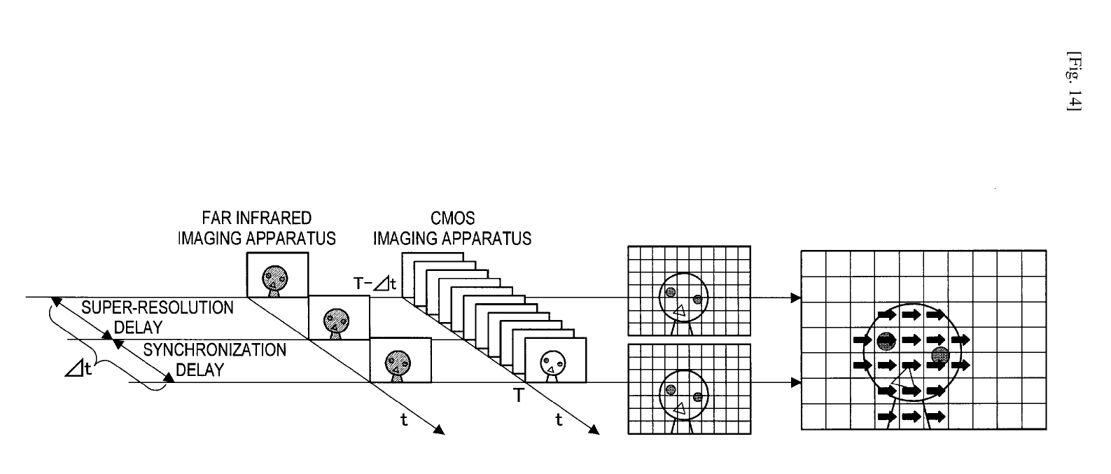

FIG. 13 is an explanatory diagram which shows a synchronization timing between the CMOS imaging apparatus 10 and the far infrared imaging apparatus 20. As shown in FIG. 13, both are synchronized every 5 frames in the CMOS imaging apparatus 10. For example, in FIG. 13, the far infrared imaging apparatus 20 images a frame F1 at the same time as the CMOS imaging apparatus 10 images a frame N5, and the far infrared imaging apparatus 20 images a frame F2 at the same time as the CMOS imaging apparatus 10 images a frame N10. Here, since a far infrared image of the frame F2 may be necessary in order for the far infrared image of the frame F1 to be super-resolution processed, a super-resolution delay becomes greater than ⅙ seconds (corresponding to 1 frame in the far infrared imaging apparatus 20). Since a synchronization delay is a delay for synchronizing a latest frame of the CMOS imaging apparatus 10 and a latest frame of the infrared image to which super-resolution has been performed, the synchronization delay becomes at most ⅙ seconds. Therefore, for example, in the case where the super-resolution process is performed with a processing time less than 1/30 seconds (corresponding to 1 frame in the CMOS imaging apparatus 10), a delay time At of the total of both will be greater than ⅙ seconds, and will be at most ⅓ seconds (corresponding to 2 frames in the far infrared imaging apparatus 20) or less.

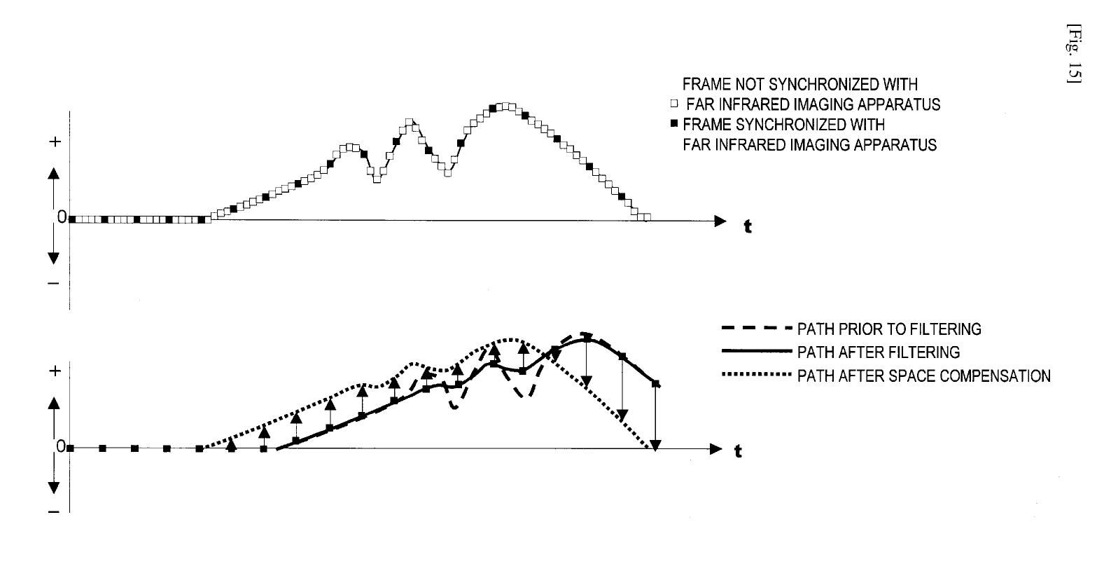

FIG. 14 is an explanatory diagram which shows an outline of a motion estimation process by the space compensation unit 368. A luminance signal from among the image signals output from the CMOS imaging apparatus 10 is made into macro blocks for each image, and edge information to which edge detection has been performed is accumulated (buffered) in the buffer unit 328. The space compensation unit 368 receives edge information in the present time T, and edge information in a time T−Δt in which a delay Δt (super-resolution delay+synchronization delay) has been considered, from the buffer unit 328, and calculates (estimates) an edge motion direction and a motion amount for each macro block by comparing both.

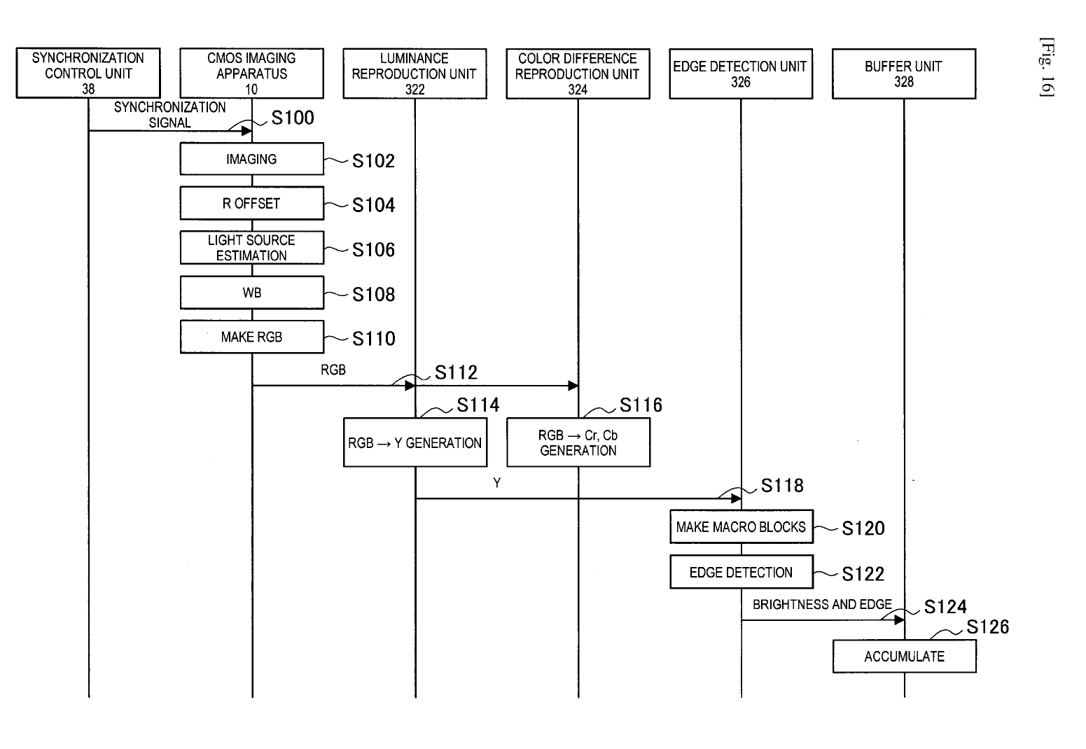

FIG. 15 is an explanatory diagram which shows an outline of a space compensation process by the space compensation unit 368. In FIG. 15, in order to make the description simple, a space compensation process in the one dimension of the left-right direction is shown as an example. The upper stage graph of FIG. 15 shows a path of a time passage centered on an object region, in an image imaged at a time T by the CMOS imaging apparatus 10. In the upper stage graph of FIG. 15, the white-filled squares show frames not synchronized with the far infrared imaging apparatus, and the black squares show frames of the time T synchronized with the far infrared imaging apparatus. The lower stage graph of FIG. 15 shows a path (broken line) of a time passage centered on an object region, a path (solid line) after filtering, and a path (dotted line) centered on this after space compensation of this object region, in an image imaged at a time T−Δt by the CMOS imaging apparatus 10 by synchronizing with the far infrared imaging apparatus. The above described filtering is filtering which performs noise removal or the like. Further, the black squares in the path after filtering show frames of a time T−Δt synchronized with the far infrared imaging apparatus. Further, the path after space compensation is obtained by compensating a spacial position such as shown by the arrows of the lower stage graph of FIG. 15, in accordance with an edge motion direction and motion amount between the time T−Δt and the time T, obtained by the above described motion estimation process.

(Synchronization Control Unit 38)

The synchronization control unit 38 generates a synchronization signal, and transmits the synchronization signal to the imaging element 12 of the CMOS imaging apparatus 10 and the imaging element 22 of the far infrared imaging apparatus 20. Further, the synchronization control unit 38 receives a completion notification of heat source region classification from the heat source region classification unit 362, calculates a delay time Δt, and performs a designation of frames to be provided to the region specification unit 36 for the buffer unit 328.

### 4. OPERATIONS

Heretofore, configurations of the CMOS imaging apparatus 10, the far infrared imaging apparatus 20 and the image processing apparatus 30 included in the imaging system 1 according to an embodiment of the present disclosure have been described. To continue, the operations of the imaging system 1 according to the present embodiment will be described. Hereinafter, a description will be sequentially performed by separating the operations of the imaging system 1 into the three types of a preparation sequence, a far infrared image processing sequence and a compensation sequence.

### 4-1. Operations by the Preparation Sequence

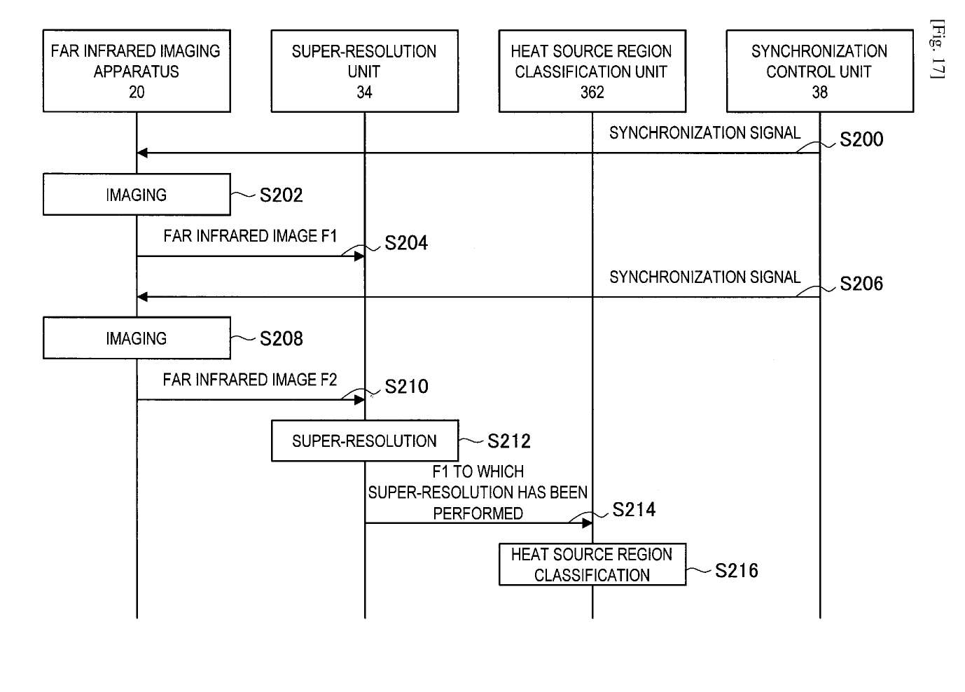

FIG. 16 is an explanatory diagram which shows the operations by the preparation sequence of the imaging system 1 according to the present embodiment. In the description of the preparation sequence, the operations will be described from imaging by the CMOS imaging apparatus 10 up until brightness images and edge information are accumulated (buffered) in the buffer unit (S126).

First, the synchronization control unit 38 sends a synchronization signal to the CMOS imaging apparatus 10 (S100). When the synchronization signal is received, the CMOS imaging apparatus 10 converts visible light and near infrared light by performing imaging into electronic signals (image signals) (S102). Next, the CMOS imaging apparatus 10 offsets an R pixel gain in a decay direction such as described with reference to FIG. 6, and enters the offset R pixel gain in a color temperature estimation table (S104). To continue, the CMOS imaging apparatus 10 estimates a lighted light source color temperature by referring to the offset color temperature estimation table (S106), and performs a WB (white balance) adjustment based on the estimated lighted light source color temperature (S108). Finally, the CMOS imaging apparatus 10 generates an RGB signal by performing a signal process such as demosaicing or gamma compensation (S110), and outputs the generated RGB signal to the image processing apparatus 30 (S112).

A luminance signal Y and color difference signals Cr and Cb are generated from the RGB signal output by the CMOS imaging apparatus 10, and are respectively input to the luminance reproduction unit 322 and the color difference reproduction unit 324 (S114, S116). To continue, the luminance signal Y in input to the edge detection unit 326 (S118), and a brightness image made into macro blocks is generated by the edge detection unit 326 (S120). The edge detection unit 326 performs edge detection from the brightness image (S122), and outputs the brightness image and the detected edge information to the buffer unit 328 (S124). Finally, the buffer unit 328 accumulates the brightness image and edge information (S126). The above described processes of steps S100 to S126 are repeatedly and continuously performed, and brightness images and edge information are continuously accumulated in the buffer unit 328.

### 4-2. Operations by the Far Infrared Image Processing Sequence

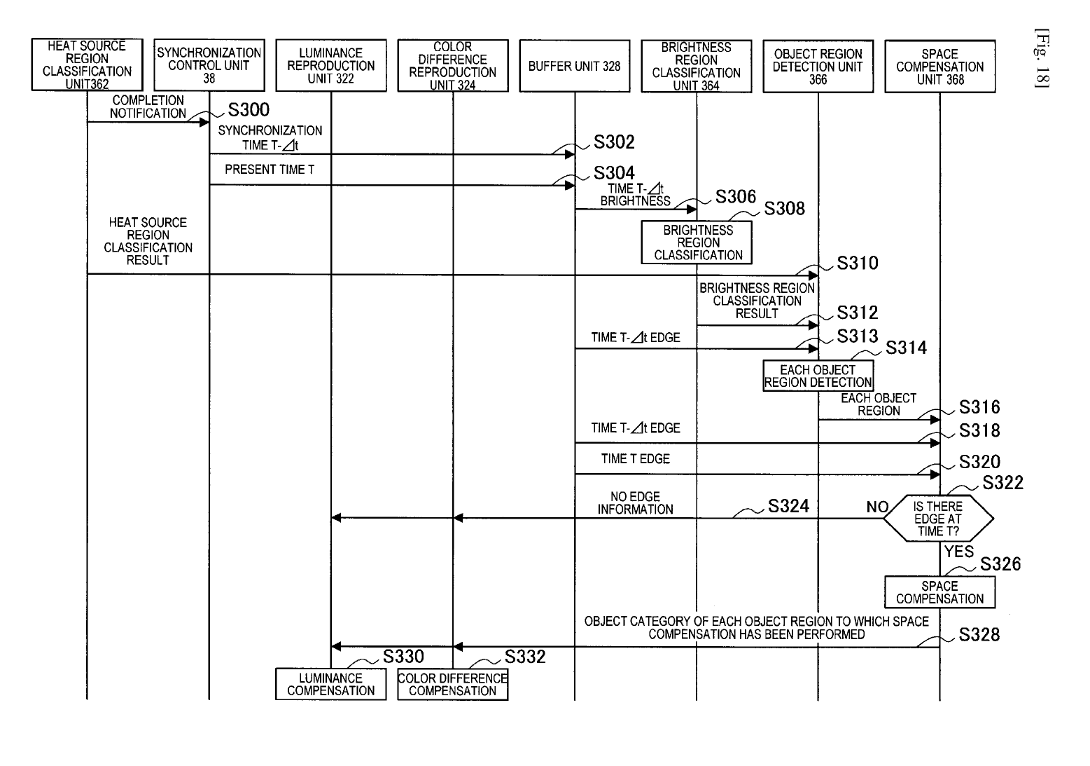

FIG. 17 is an explanatory diagram which shows the operations by the far infrared image processing sequence of the imaging system 1 according to the present embodiment. In the description of the far infrared image processing sequence, the operations will be described from imaging by the far infrared imaging apparatus 20 up until a classification of heat source regions by the heat source region classification unit 362.

First, the synchronization control unit 38 sends a synchronization signal to the far infrared imaging apparatus 20 (S200). Since the frame rates by the CMOS imaging apparatus 10 and the far infrared imaging apparatus 20 are different such as described above, the far infrared imaging apparatus 20 performs imaging, once each time a synchronization signal is received a prescribed number of times (S202). A far infrared image Fl acquired by the imaging of the far infrared imaging apparatus 20 is input to the super-resolution unit 34 (S204), and the super-resolution unit 34 waits for an input of a far infrared image of the next frame.

To continue, when the synchronization signal received from the synchronization control unit 38 by the far infrared imaging apparatus 20 again reaches a predetermined number of times (S206), the far infrared imaging apparatus 20 performs imaging again (S208), and outputs a far infrared image F2 to the super-resolution unit 34 (S210). The super-resolution unit 34 performs a super-resolution process of the far infrared image F1, by using difference information of the far infrared images F1 and F2 (S212). The far infrared image F1 to which super-resolution has been performed is input to the heat source region classification unit 362 (S214), and is classified into regions with a heat source and regions without a heat source, by the heat source region classification unit 362 (S216). The above described processes of steps S200 to S216 are repeatedly and continuously performed, and are performed in parallel with the above described preparation sequence.

### 4-3. Operations by the Compensation Sequence

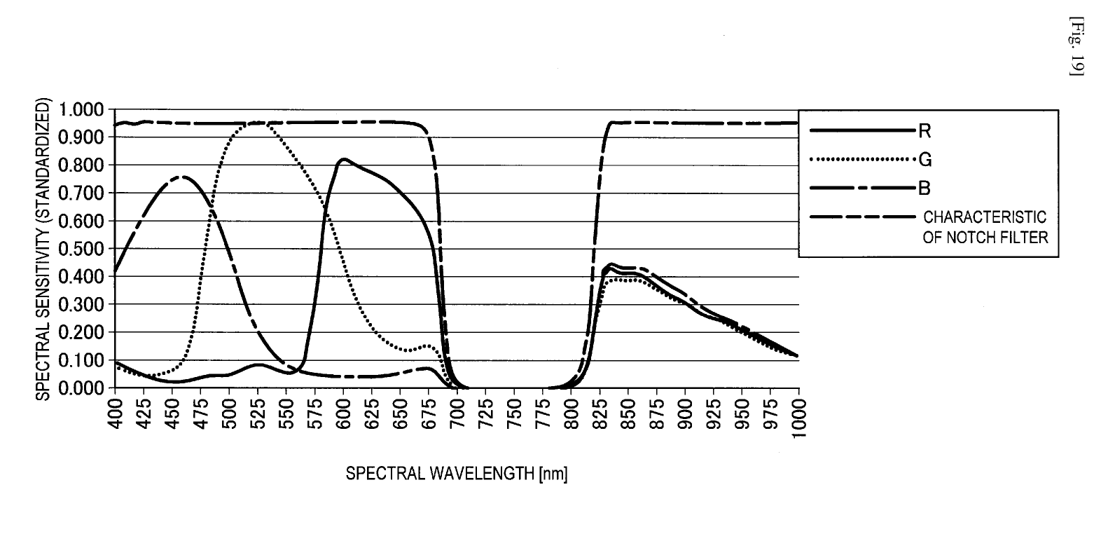

FIG. 18 is an explanatory diagram which shows the operations by the compensation sequence of the imaging system 1 according to the present embodiment. In the description of the compensation sequence, the operations will be described from the state in which brightness images and edge information have been accumulated in the buffer unit 328, and the heat source region classification unit 362 has completed classification of the heat source regions of a far infrared image, up until luminance compensation and color difference compensation by the luminance reproduction unit 322 and the color difference reproduction unit 324.

First, assuming a state where brightness images and edge information of the frames up until the present point have already been accumulated in the buffer unit 328, the compensation sequence starts from the step where the heat source region classification unit 362 notifies a completion of the heat source region classification of a far infrared image to the synchronization control unit 38 (S300). When a completion notification of the heat source region classification is received, the synchronization control unit 38 notifies an imaging time T−Δt of the frame in which heat source region classification has been completed, and the present time T, to the buffer unit (S302, S304).

Next, the brightness region classification unit 364 receives a brightness image of the time T−Δt from the buffer unit 328 (S306), and classifies the brightness image into regions with a high to medium brightness and regions with a medium to low brightness by allowing duplication of the regions (S308). The object region detection unit 366 receives a heat source region classification result, a brightness region classification result, and edge information of the time T−Δt (S310, S312, S313), performs an object detection operation corresponding to a detection object category determined based on the two received region classification results, and detects each object region (S314).

To continue, the space compensation unit 368 receives each object region, and edge information of the time T−Δt and the time T (S316, S318, S320). Here, the space compensation unit 368 determines whether or not an edge has been detected at the time T, and in the case where an edge has not been detected at the time T (NO in S322), notifies that there is no edge in this frame to the luminance reproduction unit 322 and the color difference reproduction unit 324 (S324). Further, in the case where an edge has been detected at the time T (YES in S322), the space compensation unit 368 performs space compensation of each object region based on a motion estimation between the edge information of the time T−Δt and the edge information of the time T such as described with reference to FIGS. 14 and 15 (S326). Finally, the space compensation unit 368 provides each object region to which space compensation has been performed (compensation target region) and information of a detection object category (region category) of these object regions to the luminance reproduction unit 322 and the color difference reproduction unit 324 (S328).

The luminance reproduction unit 322 compensates the gradation and contrast of luminance of each object region, based on the characteristic corresponding to the detection object category (region category), such as described with reference to FIGS. 8 and 11 (S330). Further, the color difference reproduction unit 324 compensates the hue and saturation of each object region in accordance with the detection object category (region category), such as described with reference to FIGS. 9 and 11. Note that, in the case where an edge has not been detected in this frame (NO in S322), the luminance reproduction unit 322 performs compensation which causes the luminance to be reduced more than the above described luminance compensation process does, and the color difference reproduction unit 324 performs compensation which causes the saturation to be reduced more than the above described color compensation does.

### 5. MODIFIED EXAMPLES

Heretofore, an embodiment of the present disclosure has been described. Hereinafter, some modified examples of the present embodiment will be described. Note that, each of the modified examples described hereinafter may be applied to the present embodiment individually, or may be applied to the present embodiment in combination. Further, each of the modified examples may be applied instead of the configuration described in the present embodiment, or may be additionally applied to the configuration described in the present embodiment.

### 5-1. First Modified Example

While an example has been described above in which an R pixel gain is decay compensated and the decay compensated R pixel gain is input to a color temperature estimation table, in order for the WB unit 16 to usually perform a light source color temperature estimation for an image signal in which the light receiving amount of an R pixel has increased, an embodiment of the present disclosure is not limited to such an example.

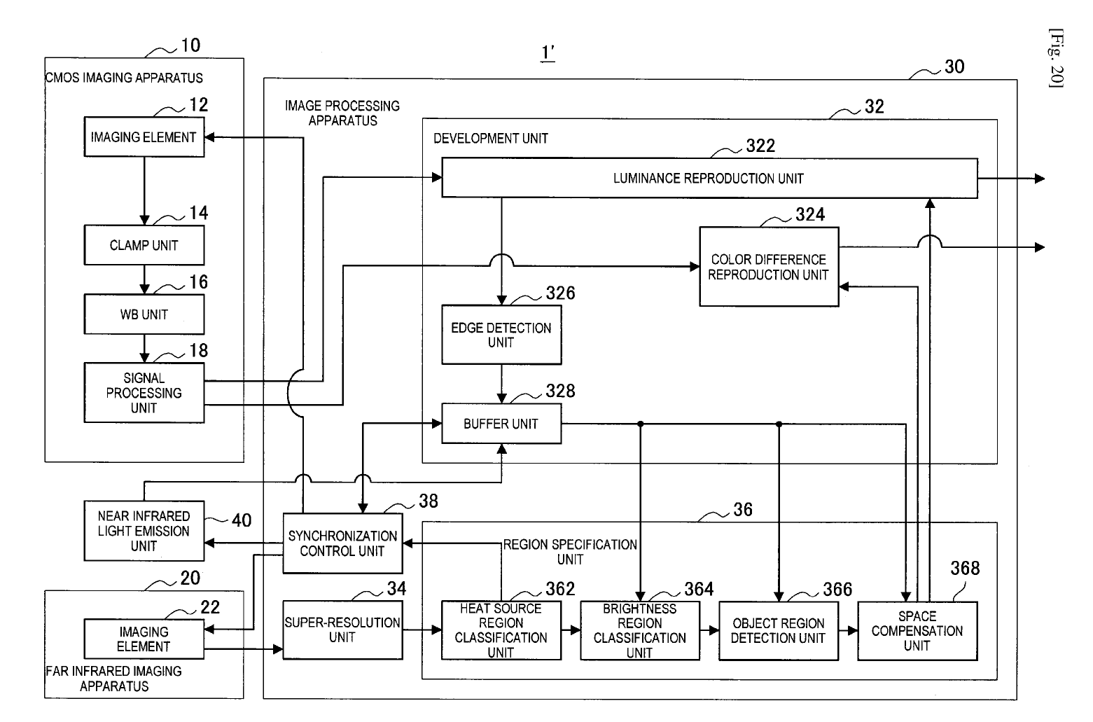

For example, the imaging system according to an embodiment of the present disclosure may prevent a light receiving amount increase of an R pixel, by inserting a notch filter (for example, a vapor deposited film or the like), which removes light of 700 nm to 800 nm, into the CMOS imaging apparatus 10. FIG. 19 is an explanatory diagram which shows spectral sensitivity characteristics of the CMOS sensor in the case where a notch filter has been inserted into the CMOS imaging apparatus 10. Since the solid line, the dotted line and single dash-dot line in the graph shown in FIG. 19 are the same as those of FIG. 3, a description of them will be omitted. The double dash-dot line in the graph shown in FIG. 19 shows a characteristic of the notch filter. As shown in FIG. 19, in the near infrared light region (from 700 nm), light of 700 nm to 800 nm with a very high light receiving sensitivity of the R pixel compared to the G pixel and the B pixel (refer to FIG. 3) is removed by the notch filter. As a result of this, as shown in FIG. 19, within the near infrared light region, near infrared light (from 800 nm) with approximately the same light receiving sensitivity of the R pixel, the G pixel and the B pixel is received.

By using the above described configuration instead of the decay compensation of an R pixel gain, the WB unit does not include a decay compensation function of an R pixel gain, and so a reduction of the processing load can be expected. Or, by additionally applying the above described configuration to the decay compensation of an R pixel gain, the WB unit can additionally perform a stable estimation of a light source color temperature and a WB adjustment.

Further, while an example has been described above in which an imaging element having CMOS imaging receives both visible light and near infrared light, this imaging element may receive only near infrared light, by using a visible light removal filter or the like. According to such a configuration, since this imaging element outputs a grayscale image corresponding to the intensity of near infrared light, without receiving visible light of colors, it may not be necessary to have a process and configuration which prevents the influence of a light receiving amount increase of an R pixel such as described above.

### 5-2. Second Modified Example

While an example has been described above in which a light source is not included in the imaging system 1, the imaging system according to an embodiment of the present disclosure may include a light source of near infrared light, for example, such as in the modified example shown below.

FIG. 20 is an explanatory diagram which shows a configuration of an imaging system 1′ including a near infrared light emission unit 40 which is a light source of near infrared light. Since the configuration other than the near infrared light emission unit 40 is the same as that of the imaging system 1 described with reference to FIG. 5, a description of this will be arbitrarily omitted.

The near infrared light emission unit 40 is an emission apparatus which emits near infrared light (for example light of 850 nm) capable of being received by the imaging element 12, for an imaging range of the CMOS imaging apparatus 10. By having the imaging system 1′ include the near infrared light emission unit 40, and image reflected light of near infrared light emitted by the near infrared light emission unit 40, it becomes possible to perform brighter imaging.

Further, the near infrared light emission unit 40 may perform light emission, by receiving a synchronization signal from the synchronization control unit 38, and synchronizing with the imaging time of the CMOS imaging apparatus 10. In addition, the near infrared light emission unit 40 may synchronize with the imaging time of the CMOS imaging apparatus 10, may perform light emission while changing a light emission intensity, and may accumulate information of the light emission intensity of each time in the buffer unit 328.

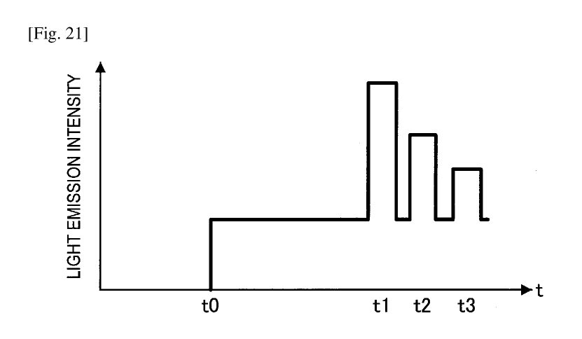

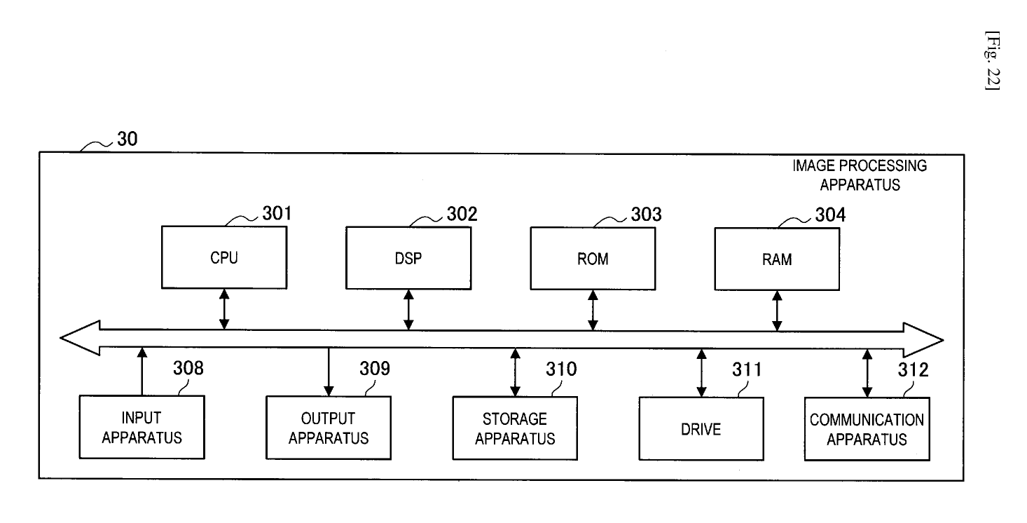

FIG. 21 is an explanatory diagram which shows a time change of the light emission intensity of the near infrared light emission unit 40. At time t0 of FIG. 21, the CMOS imaging apparatus 10 starts imaging, and the near infrared light emission unit 40 starts light emission. At times t1, t2 and t3, the near infrared light emission unit 40 receives a synchronization signal, and performs light emission while changing the light emission intensity respectively to strong, medium and weak. Further, at t1, t2 and t3, the near infrared light emission unit 40 provides information of the light emission intensity to the buffer unit 328.

Here, the brightness region classification unit 364 determines the height of the reflection rate of the near infrared light band of a photographic subject, based on the brightness image and light emission intensity received from the buffer unit 328, and performs a brightness region classification with a higher accuracy. According to such a configuration, by having the classification of brightness regions become a high accuracy, an improvement in object region detection, luminance reproduction and color difference reproduction can be expected.

### 6. HARDWARE CONFIGURATION OF THE IMAGE PROCESSING APPARATUS

FIG. 22 is an explanatory diagram which shows a hardware configuration of the image processing apparatus 30. As shown in FIG. 22, the image processing apparatus 30 includes a Central Processing Unit (CPU) 301, Digital Signal Processor (DSP) 302, a Read Only Memory (ROM) 303, a Random Access Memory (RAM) 304, an input apparatus 308, an output apparatus 309, a storage apparatus 310, a drive 311, and a communication apparatus 312.

The CPU 301 functions as an operation processing apparatus and a control apparatus, and controls all the operations within the image processing apparatus 30 in accordance with various types of programs. Further, the CPU 301 may be a microprocessor. The DSP 302 functions as a signal processing apparatus, and performs an edge detection process or the like, for example, which is a function of the edge detection unit 326 of the image processing apparatus 30 according to the present embodiment. Further, the DSP 302 may be a microprocessor. The ROM 303 stores programs and operation parameters used by the CPU 301. The RAM 304 temporarily stores programs used in the execution of the CPU 301, and parameters which arbitrarily change in this execution. These sections are mutually connected by a host bus constituted from a CPU bus or the like.

The input apparatus 308 includes an input section, such as a mouse, a keyboard, a touch panel, buttons, a microphone, switches or leavers, for a user to input information, and an input control circuit which generates an input signal based on an input by the user, and outputs the input signal to the CPU 301. By operating the input apparatus 308, it is possible for the user of the image processing apparatus 30 to input various types of data for the image processing apparatus 30 and to instruct the process operations.

The output apparatus 309 includes, for example, a display device such as a liquid crystal display (LCD) apparatus, an Organic Light Emitting Diode (OLED) apparatus, or a lamp. In addition, the output apparatus 309 includes a sound output apparatus such as a speaker or headphones. For example, the display device displays an imaged image or a generated image. On the other hand, the sound output apparatus converts sound data and outputs sounds.

The storage apparatus 310 is an apparatus for data storage constituted as an example of the buffer unit 328 of the image processing apparatus 30 according to the present embodiment. The storage apparatus 310 may include a storage medium, a recording apparatus which records data to the storage medium, a reading apparatus which reads data from the storage medium, and an erasure apparatus which erases data recorded in the storage medium. This storage apparatus 310 stores programs executed by the CPU 301 and various types of data.

The drive 311 is a reader/writer for the storage medium, and is built into the image processing apparatus 30 or is externally attached. The drive 311 reads information recorded on a removable storage medium, such as a mounted magnetic disk, an optical disk, a magneto-optical disk, or a semiconductor memory, and outputs the information to the RAM 304. Further, the drive 311 can write information to the removable storage medium.

The communication apparatus 312 is a communication interface constituted by a communication device or the like. Further, even if the communication apparatus 312 is a communication apparatus adaptive to a wireless Local Area Network (LAN) or Long Term Evolution (LTE), the communication apparatus 312 may be a wired communication apparatus which communicates by wires.

### 7. CONCLUSION

According to an embodiment of the present disclosure such as described above, a compensation target region and a region category of a visible and near infrared image is specified, based on a visible and near infrared image and a far infrared image, and the contrast of luminance, the hue and saturation of colors or the like is compensated in accordance with the region category for this compensation target region. Note that, it is possible for an embodiment of the present disclosure to be applied, for example, to a vehicle camera or a security camera.

It should be understood by those skilled in the art that various modifications, combinations, sub-combinations and alterations may occur depending on design requirements and other factors insofar as they are within the scope of the appended claims or the equivalents thereof.

For example, in the above described embodiment, while an example has been described in which a CMOS sensor having a primary color filter (RGB) by red, green and blue (RGB), which are primary colors, is used as an imaging element capable of receiving near infrared light, this is an example of an imaging element, and an embodiment of the present disclosure is not limited to such an example. For example, instead of a CMOS sensor, a CCD sensor may be used. Further, for example, instead of an imaging element having a primary color filter, an imaging element having a complementary color filter by cyan, magenta, yellow and green (CMYG), which are complementary colors, may be used.

Further, for example, in the above described embodiment, while an example has been described in which the image processing apparatus includes a synchronization control unit, and the CMOS imaging apparatus and the far infrared imaging apparatus perform synchronous imaging at certain intervals, an embodiment of the present disclosure is not limited to such an example. For example, instead of not performing synchronous imaging, a time code may be provided to a far infrared image, and the buffer unit may provide a visible and near infrared image photographed at a nearest time based on the time code to the region specification unit.

Further, for example, in the above described embodiment, while an example has been described in which the image processing apparatus includes a super-resolution unit, and performs a super-resolution process of a far infrared image, an embodiment of the present disclosure is not limited to such an example. For example, the image processing apparatus may not perform a super-resolution process, and may perform a process of heat source region classification for a far infrared image received from the far infrared imaging apparatus.

Further, for example, in the above described embodiment, while an example has been described in which the CMOS imaging apparatus does not include an IRCF, an embodiment of the present disclosure is not limited to such an example. For example, the imaging system may include an IRCF and a mechanism which detaches the IRCF, and may function as a general visible light photographing system in the case where imaging by attaching the IRCF, and may perform luminance and color difference compensation such as in the above described embodiment in the case where imaging by removing the IRCF.

In addition, the effects described in the present specification are merely illustrative and demonstrative, and not limitative. In other words, the technology according to the present disclosure can exhibit other effects that are evident to those skilled in the art along with or instead of the effects based on the present specification.

The present disclosure may have the following configurations.

(1) An imaging device, comprising: first imaging circuitry that captures at least near infrared (NIR) light and outputs an NIR image, second imaging circuitry that captures far infrared (FIR) light and outputs an FIR image, wherein the FIR light has a longer wavelength than the NIR light, and processing circuitry configured to adjust color of the NIR image based on the FIR image.

(2) The imaging device according to (1), wherein the processing circuitry is further configured to obtain, from the first imaging circuitry, the NIR image having a first frame rate and configured to obtain, from the second imaging circuitry, the FIR image having a second frame rate, lower than the first frame rate.

(3) The imaging device according to (1) or (2), wherein the processing circuitry is further configured to, prior to the adjusting of the color of the NIR image, synchronize color information generated by the FIR image with the NIR image.

(4) The imaging device according to any one of (1) to (3), wherein the processing circuitry is configured to adjust the color of a target region of the NIR image based on the FIR image.

(5) The imaging device according to (4), wherein the processing circuitry is further configured to, prior to the adjusting of the color of the NIR image, specify the target region of the NIR image based on edges of the NIR image.

(6) The imaging device according to (4) of (5), wherein the processing circuitry is further configured to, prior to the adjusting of the color of the NIR image, specify a region category of the target region based on a difference between two frames respectively corresponding to the NIR image and a subsequent NIR image.

(7) The imaging device according to (6), wherein the processing circuitry is further configured to adjust the color of the NIR image based on the region category of the target region of the NIR image.

(8) The imaging device according to any one of (1) to (7), wherein a resolution of the FIR image is lower than a resolution of the NIR image.

(9) The imaging device according (8), wherein the processing circuitry is further configured to apply a super-resolution process to the FIR image.

(10) The imaging device according to (9), wherein the processing circuitry is further configured to execute the super-resolution process using difference information between the FIR image and a subsequent FIR image.

(11) The imaging device according to any one of (1) to (10), wherein the processing circuitry is further configured to generate temperature information based on the FIR image, and adjust the color of the NIR image based on the temperature information.

(12) The imaging device according to (4), wherein the processing circuitry is further configured to, prior to the adjusting of the color of the NIR image, specify the target region of the NIR image based on temperature information generated by the FIR image.

(13) The imaging device according to (5), wherein the processing circuitry is configured to specify the edges based on temperature information generated by the FIR image and to specify the target region of the NIR image based on the edges.

(14) The imaging device according to (5) or (13), wherein when the edges for the target region are detectable without temperature information color adjustment in the target region specified by the edge information has higher luminance than color adjustment in the target region when the edges for the target region are detectable with temperature information.

(15) The imaging device according to (2), wherein the first frame rate is divisible by the second frame rate.

(16) The imaging device according to any one of (1) to (15), wherein the first imaging circuitry and the second imaging circuitry are a single imaging circuitry.

(17) An apparatus comprising: processing circuitry configured to obtain a first image from one or more imaging circuitry that captures at least a first wavelength light, obtain a second image from the one or more imaging circuitry that captures at least a second wavelength light which is longer than the first wavelength light, and generate at least one of color correction information and/or luminance correction information based on the second image for application to the first image.

(18) An apparatus comprising: a far infrared (FIR) light imager configured to generate image information, and processing circuitry configured to: obtain temperature information from the generated image information, determine color information in accordance with the temperature information, and output the color information.

(19) An imaging method, comprising: capturing at least near infrared (NIR) light with first imaging circuitry, outputting an NIR image, capturing far infrared (FIR) light, wherein the FIR light has a longer wavelength than the NIR light, with second imaging circuitry, outputting an FIR image, and adjusting color of the NIR image based on the FIR image.

(20) The imaging method to (19), further comprising: obtaining, using the processing circuity and from the first imaging circuitry, the NIR image having a first frame rate, and obtaining, using the processing circuitry and from the second imaging circuitry, the FIR image having a second frame rate, lower than the first frame rate.

(21) The imaging method according to (19) or (20), further comprising: synchronizing, using the processing circuitry and prior to the adjusting of the color of the NIR image, color information generated by the FIR image with the NIR image.

(22) The imaging method according to any one of (19) to (21), further comprising: adjusting, using the processing circuitry, the color of a target region of the NIR image based on the FIR image.

(23) The imaging method according to (22), further comprising: specifying, using the processing circuity and prior to the adjusting of the color of the NIR image, the target region of the NIR image based on edges of the NIR image.

(24) The imaging method according to (22) or (23), further comprising: specifying, using the processing circuitry and prior to the adjusting of the color of the NIR image, a region category of the target region based on a difference between two frames respectively corresponding to the NIR image and a subsequent NIR image.

(25) The imaging method according to (24), further comprising: adjusting, using the processing circuitry, the color of the NIR image based on the region category of the target region of the NIR image.

(26) The imaging method according any one of (19) to (25), further comprising: applying, using the processing circuitry, a super-resolution process to the FIR image.

(27) The imaging method according to (26), further comprising: executing, using the processing circuitry, the super-resolution process using difference information between the FIR image and a subsequent FIR image.

(28) The imaging method according to any one of (19) to (27), further comprising: generating, using the processing circuitry, temperature information based on the FIR image, and adjusting, using the processing circuitry, the color of the NIR image based on the temperature information.

(29) The imaging method according to (22), further comprising: specifying, using the processing circuitry and prior to the adjusting of the color of the NIR image, the target region of the NIR image based on temperature information generated by the FIR image.

(30) The imaging method according to (23), further comprising: specifying, using the processing circuitry, the edges based on temperature information generated by the FIR image and to specify the target region of the NIR image based on the edges.

(31) An image processing apparatus including: a region specification unit which specifies a compensation target region and a region category of the compensation target region, based on a first image obtained based on an imaging element having sensitivity to far infrared light, in a second image obtained based on an imaging element having sensitivity to at least near infrared light; and a compensation unit which performs at least one of color compensation or luminance compensation corresponding to the region category for the compensation target region specified by the region specification unit.

(32) The image processing apparatus according to (31), wherein the region specification unit specifies the compensation target region and the region category additionally based on the second image.

(33) The image processing apparatus according to (31) or (32), wherein the region specification unit specifies the compensation target region based on a photographic subject temperature of each position in the first image, the photographic subject temperature being specified from the first image.

(34) The image processing apparatus according to (32) or (33), wherein the region specification unit specifies the compensation target region based on a brightness of each position in the second image.

(35) The image processing apparatus according to any one of (32) to (34), further including: a buffer unit which performs buffering of image feature information extracted from the second image, wherein the region specification unit specifies the compensation target region and the region category based on the first image obtained at a first time, and the image feature information extracted from the second image obtained at the first time and buffered in the buffer unit.

(36) The image processing apparatus according to (35), wherein the region specification unit specifies a reference region based on the first image obtained at the first time, and the image feature information extracted from the second image obtained at the first time and buffered in the buffer unit, performs a motion estimation based on the image feature information extracted from the second image obtained at a second time after the first time, and the image feature information extracted from the second image obtained at the first time, and specifies a region obtained by compensating the reference region based on an estimated motion as the compensation target region, and wherein the compensation unit performs at least one of color compensation or luminance compensation corresponding to the region category for the compensation target region specified by the region specification unit obtained at the second time.

(37) The image processing apparatus according to (35) or (36), wherein a number of the second images obtained in a prescribed time is greater than a number of the first images obtained in the prescribed time.

(38) The image processing apparatus according to any one of (32) to (37), wherein the region specification unit specifies a detection target region and a detection object category, based on the first image and the second image, in the second image, detects an object region corresponding to the detection object category from the specified detection target region, and specifies the compensation target region based on the detected object region.

(39) The image processing apparatus according to (38), further including: an edge detection unit which detects an edge from the second image, wherein the region specification unit detects the object region based on the edge.

(40) The image processing apparatus according to (39), wherein, in a case where the edge has not been detected by the edge detection unit, the compensation unit performs compensation for all or a part of the second image, the compensation causing a luminance and a saturation to be reduced more than the color compensation or the luminance compensation performed in a case where the edge has been detected does.

(41) The image processing apparatus according to any one of (31) to (39), wherein a method of the color compensation includes compensating a hue and a saturation of the compensation target region based on a hue saturation objective value corresponding to the region category.

(42) The image processing apparatus according to any one of (31) to (40), wherein a method of the luminance compensation includes performing compensation of a brightness of the compensation target region corresponding to the region category, and performing compensation of a contrast of the compensation target region corresponding to the region category.

(43) The image processing apparatus according to any one of (31) to (42), wherein the second image is obtained based on the imaging element having sensitivity to at least visible light and near infrared light.

(44) The image processing apparatus according to (43), wherein the second image is obtained based on a white balance adjustment for a plurality of signals showing blue, green and red that have been obtained by the imaging element having sensitivity to at least visible light and near infrared light, decay compensation having been performed for a signal showing red from among the plurality of signals.

(45) An image processing method including: specifying a compensation target region and a region category, based on a first image obtained based on an imaging element having sensitivity to far infrared light, in a second image obtained based on an imaging element having sensitivity to at least near infrared light; and performing, by a processor, at least one of color compensation or luminance compensation corresponding to the region category for the compensation target region.

(46) An imaging system including: a first imaging element having sensitivity to far infrared light; a second imaging element having sensitivity to at least near infrared light; a region specification unit which specifies a compensation target region and a region category, based on a first image obtained based on the first imaging element, in a second image obtained based on the second imaging element; and a compensation unit which performs at least one of color compensation or luminance compensation corresponding to the region category for the compensation target region specified by the region specification unit.

(47) The imaging system according to (46), further including: a near infrared light emission unit which emits near infrared light while changing an intensity in synchronization with the second imaging element, wherein the region specification unit specifies the compensation target region and the region category additionally based on the intensity of near infrared light emitted by the near infrared light emission unit.

### REFERENCE SIGNS LIST

1 imaging system

10 imaging apparatus

12 imaging element

14 clamp unit

16 WB unit

18 signal processing unit

20 far infrared imaging apparatus

22 imaging element

30 image processing apparatus

32 development unit

34 super-resolution unit

36 region specification unit

38 synchronization control unit

40 near infrared light emission unit

322 luminance reproduction unit

324 color difference reproduction unit

326 edge detection unit

328 buffer unit

362 heat source region classification unit

364 brightness region classification unit

366 object region detection unit

368 space compensation unit

1. An imaging device, comprising:
first imaging circuitry that captures at least near infrared (NIR) light and outputs an NIR image;
second imaging circuitry that captures far infrared (FIR) light and outputs an FIR image, wherein the FIR light has a longer wavelength than the NIR light; and
processing circuitry configured to
adjust color of the NIR image based on the FIR image.

2. The imaging device according to claim 1, wherein the processing circuitry is further configured to obtain, from the first imaging circuitry, the NIR image having a first frame rate and configured to obtain, from the second imaging circuitry, the FIR image having a second frame rate, lower than the first frame rate.

3. The imaging device according to claim 2, wherein the processing circuitry is further configured to, prior to the adjusting of the color of the NIR image, synchronize color information generated by the FIR image with the NIR image.

4. The imaging device according to claim 1, wherein the processing circuitry is configured to adjust the color of a target region of the NIR image based on the FIR image.

5. The imaging device according to claim 4, wherein the processing circuitry is further configured to, prior to the adjusting of the color of the NIR image, specify the target region of the NIR image based on edges of the NIR image.

6. The imaging device according to claim 5, wherein the processing circuitry is further configured to, prior to the adjusting of the color of the NIR image, specify a region category of the target region based on a difference between two frames respectively corresponding to the NIR image and a subsequent NIR image.

7. The imaging device according to claim 6, wherein the processing circuitry is further configured to adjust the color of the NIR image based on the region category of the target region of the NIR image.

8. The imaging device according to claim 1, wherein a resolution of the FIR image is lower than a resolution of the NIR image.

9. The imaging device according claim 8, wherein the processing circuitry is further configured to apply a super-resolution process to the FIR image.

10. The imaging device according to claim 9, wherein the processing circuitry is further configured to execute the super-resolution process using difference information between the FIR image and a subsequent FIR image.

11. The imaging device according to claim 1, wherein the processing circuitry is further configured to
generate temperature information based on the FIR image, and
adjust the color of the NIR image based on the temperature information.

12. The imaging device according to claim 4, wherein the processing circuitry is further configured to, prior to the adjusting of the color of the NIR image, specify the target region of the NIR image based on temperature information generated by the FIR image.

13. The imaging device according to claim 5, wherein the processing circuitry is configured to specify the edges based on temperature information generated by the FIR image and to specify the target region of the NIR image based on the edges.

14. The imaging device according to claim 5, wherein when the edges for the target region are detectable without temperature information color adjustment in the target region specified by the edge information has higher luminance than color adjustment in the target region when the edges for the target region are detectable with temperature information.

15. The imaging device according to claim 2, wherein the first frame rate is divisible by the second frame rate.

16. The imaging device according to claim 1, wherein the first imaging circuitry and the second imaging circuitry are a single imaging circuitry.

17. An apparatus comprising:
processing circuitry configured to
obtain a first image from one or more imaging circuitry that captures at least a first wavelength light,
obtain a second image from the one or more imaging circuitry that captures at least a second wavelength light which is longer than the first wavelength light, and
generate at least one of color correction information and/or luminance correction information based on the second image for application to the first image.

18. An apparatus comprising:
a far infrared (FIR) light imager configured to generate image information; and
processing circuitry configured to:
obtain temperature information from the generated image information,
determine color information in accordance with the temperature information, and
output the color information.

19. An imaging method, comprising:
capturing at least near infrared (NIR) light with first imaging circuitry;
outputting an NIR image;
capturing far infrared (FIR) light, wherein the FIR light has a longer wavelength than the NIR light, with second imaging circuitry;
outputting an FIR image; and
adjusting color of the NIR image based on the FIR image.

20. The imaging method to claim 19, further comprising:
obtaining, using the processing circuity and from the first imaging circuitry, the NIR image having a first frame rate; and
obtaining, using the processing circuitry and from the second imaging circuitry, the FIR image having a second frame rate, lower than the first frame rate.

21. The imaging method according to claim 20, further comprising:
synchronizing, using the processing circuitry and prior to the adjusting of the color of the NIR image, color information generated by the FIR image with the NIR image.

22. The imaging method according to claim 19, further comprising:
adjusting, using the processing circuitry, the color of a target region of the NIR image based on the FIR image.

23. The imaging method according to claim 22, further comprising:
specifying, using the processing circuity and prior to the adjusting of the color of the NIR image, the target region of the NIR image based on edges of the NIR image.

24. The imaging method according to claim 23, further comprising:
specifying, using the processing circuitry and prior to the adjusting of the color of the NIR image, a region category of the target region based on a difference between two frames respectively corresponding to the NIR image and a subsequent NIR image.

25. The imaging method according to claim 24, further comprising:
adjusting, using the processing circuitry, the color of the NIR image based on the region category of the target region of the NIR image.

26. The imaging method according claim 19, further comprising:
applying, using the processing circuitry, a super-resolution process to the FIR image.

27. The imaging method according to claim 26, further comprising:
executing, using the processing circuitry, the super-resolution process using difference information between the FIR image and a subsequent FIR image.

28. The imaging method according to claim 19, further comprising:
generating, using the processing circuitry, temperature information based on the FIR image, and
adjusting, using the processing circuitry, the color of the NIR image based on the temperature information.

29. The imaging method according to claim 22, further comprising:
specifying, using the processing circuitry and prior to the adjusting of the color of the NIR image, the target region of the NIR image based on temperature information generated by the FIR image.

30. The imaging method according to claim 23, further comprising:
specifying, using the processing circuitry, the edges based on temperature information generated by the FIR image and to specify the target region of the NIR image based on the edges.
